(19) United States
(12) Patent Application Publication
(10) Pub. No.: US 2025/0217004 A1
(43) Pub. Date: Jul. 3, 2025

(54) VIRTUAL OBJECT INTERACTION METHOD AND APPARATUS, COMPUTER DEVICE, AND STORAGE MEDIUM

(71) Applicant: Tencent Technology (Shenzhen) Company Limited, Shenzhen (CN)

(72) Inventor: Qi SANG, Shenzhen (CN)

(21) Appl. No.: 19/085,922

(22) Filed: Mar. 20, 2025

Related U.S. Application Data
(63) Continuation of application No. PCT/CN2023/131254, filed on Nov. 13, 2023.

(30) Foreign Application Priority Data
Mar. 30, 2023 (CN) 202310331255.5

(51) Int. Cl. G06F 3/04815; G06T 15/04

(52) U.S. Cl. CPC G06F 3/04815; G06T 15/04

(57) ABSTRACT

A virtual object interaction method is performed by a computer device. The method includes: identifying, in response to an interaction operation on a virtual object in a virtual scene, a color value at an interaction location indicated by the interaction operation; determining, from a pre-configured correspondence between respective parts of the virtual object and color values, a part of the virtual object matching the color value of the interaction location, and obtaining posture data of the virtual object determining a first feedback action type matching the posture data of the virtual object and the matching part of the virtual object; and controlling, based on the first feedback action type, the virtual object to perform a feedback action corresponding to the matching part of the virtual object.

### CROSS-REFERENCE TO RELATED APPLICATIONS

This application is a continuation application of PCT Patent Application No. PCT/CN2023/131254, entitled “VIRTUAL OBJECT INTERACTION METHOD AND APPARATUS, COMPUTER DEVICE, AND STORAGE MEDIUM” filed on Nov. 13, 2023, which claims priority to Chinese Patent Application No. 2023103312555, entitled “VIRTUAL OBJECT INTERACTION METHOD AND APPARATUS, COMPUTER DEVICE, AND STORAGE MEDIUM” filed with the China National Intellectual Property Administration on Mar. 30, 2023 and, all of which are incorporated herein by reference in their entirety.

### FIELD OF THE TECHNOLOGY

This application relates to the field of computer technologies, and in particular, to a virtual object interaction method and apparatus, a computer device, a storage medium, and a computer program product.

### BACKGROUND OF THE DISCLOSURE

With the development of computer technologies, a virtual object interaction application appears. An interaction object may interact with a virtual object by using the virtual object interaction application. For example, the virtual object may be specifically a virtual person or a virtual pet.

In conventional technologies, a virtual object interaction manner is to control the virtual object to perform a pre-configured one-time feedback action in response to an interaction operation triggered by the interaction object in the virtual object interaction application when the virtual object is displayed in the virtual object interaction application. However, because the virtual object is controlled to perform the pre-configured one-time feedback action by using only the interaction operation in a current virtual object interaction manner, the single virtual object interaction manner is monotonous, and resources of the virtual object cannot be fully utilized, resulting in low resource utilization.

### SUMMARY

According to various embodiments of this application, a virtual object interaction method and apparatus, a computer device, a computer-readable storage medium, and a computer program product are provided.

According to a first aspect, this application provides a virtual object interaction method performed by a computer device. The method includes:
identifying, in response to an interaction operation on a virtual object in a virtual scene, a color value at an interaction location indicated by the interaction operation;
determining, from a pre-configured correspondence between respective parts of the virtual object and color values, a part of the virtual object matching the color value of the interaction location, and obtaining posture data of the virtual object;
determining a first feedback action type matching the posture data of the virtual object and the matching part of the virtual object; and
controlling, based on the first feedback action type, the virtual object to perform a feedback action corresponding to the matching part of the virtual object.

According to another aspect, this application further provides a computer device, including a memory and a processor, the memory having computer-readable instructions stored therein, the processor, when executing the computer-readable instructions, implementing the operations in the method embodiments of this application.

According to another aspect, this application further provides a non-transitory computer-readable storage medium. The computer-readable storage medium has computer-readable instructions stored therein, the computer-readable instructions, when executed by a processor, implementing the operations in the method embodiments of this application.

According to another aspect, this application further provides a computer program product. The computer program product includes computer-readable instructions, the computer-readable instructions, when executed by a processor, implementing the operations in the method embodiments of this application.

Details of one or more embodiments of this application are provided in the accompanying drawings and descriptions below. Other features and advantages of this application are illustrated in the specification, the accompanying drawings, and the claims.

### BRIEF DESCRIPTION OF THE DRAWINGS

To describe the technical solutions in the embodiments of this application or the conventional technology more clearly, the following briefly describes the accompanying drawings required for describing the embodiments or the conventional technology. Apparently, the accompanying drawings in the following description show merely the embodiments of this application, and a person of ordinary skill in the art may still derive other drawings from these accompanying drawings without creative efforts.

FIG. 1 is a diagram of an application environment of a virtual object interaction method according to an embodiment.

FIG. 2 is a schematic flowchart of a virtual object interaction method according to an embodiment.

FIG. 3 is a schematic diagram of a posture of a virtual object according to an embodiment.

FIG. 4 is a schematic diagram of a part partition texture map according to an embodiment.

FIG. 5 is a schematic diagram of a color texture map obtained through rendering according to an embodiment.

FIG. 6 is a schematic diagram of a horizontal direction control parameter and a vertical direction control parameter according to an embodiment.

FIG. 7 is a schematic diagram of a facial animation parameter range according to an embodiment.

FIG. 8 is a schematic diagram of a virtual cat lowering its head according to an embodiment.

FIG. 9 is a schematic diagram of a virtual cat raising its head according to an embodiment.

FIG. 10 is a schematic diagram of interaction expected to be achieved by virtual pet interaction according to an embodiment.

FIG. 11 is an interaction flowchart from partition to interaction according to an embodiment.

FIG. 12 is a schematic diagram of face sliding interaction according to an embodiment.

FIG. 13 is a schematic diagram of foot sliding interaction according to an embodiment.

FIG. 14 is a schematic diagram of a basic posture of a virtual object according to an embodiment.

FIG. 15 is a schematic diagram of an animation state machine according to an embodiment.

FIG. 16 is a schematic flowchart of a virtual object interaction method according to an embodiment.

FIG. 17 is a schematic diagram of virtual cats of different body shapes obtained by performing a sculpting operation according to an embodiment.

FIG. 18 is a schematic diagram of displaying an interaction trigger location according to an embodiment.

FIG. 19 is a structural block diagram of a virtual object interaction apparatus according to an embodiment.

FIG. 20 is a structural block diagram of a virtual object interaction apparatus according to an embodiment.

FIG. 21 is a diagram of an internal structure of a computer device according to an embodiment.

### DESCRIPTION OF EMBODIMENTS

The technical solutions in the embodiments of this application are clearly and completely described below with reference to accompanying drawings in the embodiments of this application. Apparently, the described embodiments are merely some rather than all of the embodiments of this application. Based on the embodiments of this application, all other embodiments obtained by a person of ordinary skill in the art without creative efforts shall fall within the protection scope of this application.

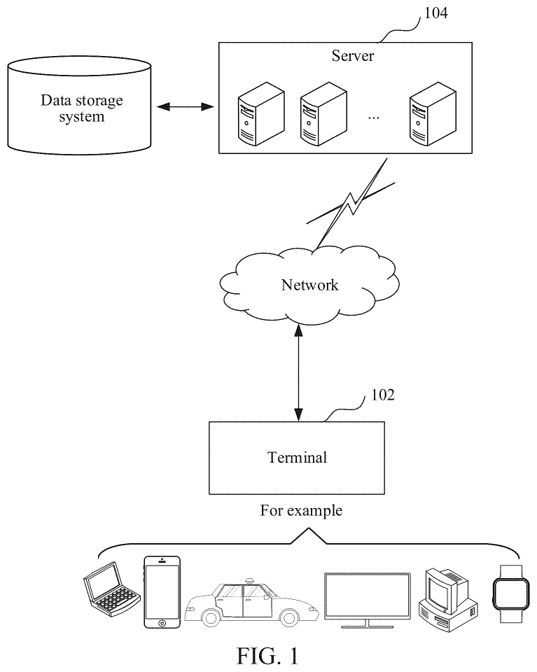

A virtual object interaction method provided in the embodiments of this application may be applied to an application environment shown in FIG. 1. A terminal 102 communicates with a server 104 through a network. A data storage system may store data that the server 104 needs to process. The data storage system may be integrated on the server 104, or placed on a cloud or another server. A client for implementing virtual object interaction is arranged on the terminal 102. The client may be an application program, a web client, or a sub-application running in an operating environment of a parent application. The terminal 102 obtains, from the server 104, a pre-configured correspondence between a part of a virtual object and a color value and a pre-configured mapping relationship among a posture of the virtual object, the part of the virtual object, and a feedback action type. When the virtual object exists in a virtual scene, the terminal 102 identifies, in response to an interaction operation triggered in the virtual scene, a color value at an interaction location indicated by the interaction operation. When the color value at the interaction location represents that the interaction operation acts on the virtual object, the terminal 102 determines, from the pre-configured correspondence between the part of the virtual object and the color value according to the color value at the interaction location, a part of the virtual object matching the color value at the interaction location; and obtains posture data of the virtual object, the posture data being configured for describing a posture of the virtual object. The terminal 102 determines, based on the pre-configured mapping relationship among the posture of the virtual object, the part of the virtual object, and the feedback action type, a first feedback action type matching the posture data and the matching part; determines a calculation manner of a posture change parameter corresponding to the first feedback action type; determines, based on the calculation manner of the posture change parameter, a posture change parameter of a feedback action of the first feedback action type relative to the matching part, the posture change parameter being a parameter configured for controlling the virtual object to perform a posture change; and controls, based on the posture change parameter, the virtual object to perform a feedback action corresponding to the matching part.

The terminal 102 may be, but is not limited to, a desktop computer, a notebook computer, a smart phone, a tablet computer, an Internet of Things device, and a portable wearable device. The Internet of Things device may be a smart speaker, a smart television, a smart air conditioner, a smart in-vehicle device, or the like. The portable wearable device may be a smart watch, a smart band, a head-mounted device, or the like. The server 104 may be implemented by using an independent server or a server cluster that includes a plurality of servers.

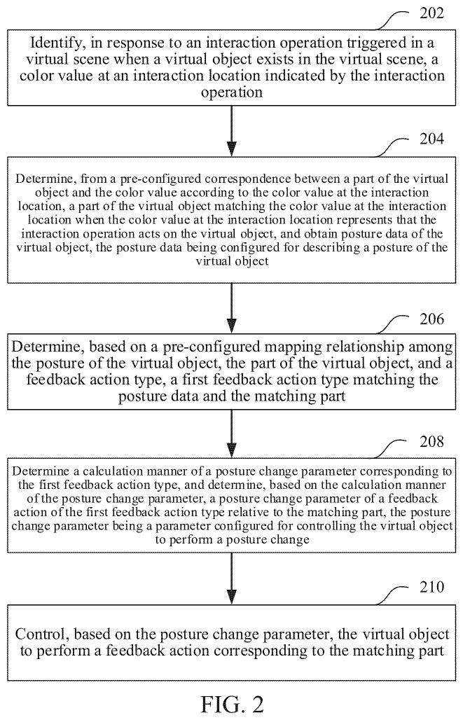

In an embodiment, as shown in FIG. 2, a virtual object interaction method is provided. The method may be independently performed by a terminal or a server, or may be jointly performed by a terminal and a server. In the embodiments of this application, an example in which the method is applied to the terminal is used for description. The method includes the following operations:

Operation 202: Identify, in response to an interaction operation triggered in a virtual scene when a virtual object exists in the virtual scene, a color value at an interaction location indicated by the interaction operation.

The virtual object is a movable object in a virtual environment. The movable object may be a virtual person, a virtual animal, or the like. The virtual environment is a virtual environment provided by the client running on the terminal. The virtual environment may be a simulated environment of a real world, or may be a semi-simulated and semi-fictional environment, or may be a completely fictional environment. For example, the virtual environment may be specifically a three-dimensional virtual environment. For another example, when the virtual environment is the three-dimensional virtual environment, the virtual object is a virtual person or a virtual animal displayed in the three-dimensional virtual environment. The virtual object has its own shape and volume in the three-dimensional virtual environment, occupying a part of the space in the three-dimensional virtual environment.

The interaction operation is an operation triggered when an interaction object performs interaction. For example, the interaction operation may be specifically a click operation triggered when the interaction object performs interaction. For example, the interaction operation may be specifically a click operation triggered by an input device when the interaction object performs interaction. The input device may be specifically a mouse, a stylus, or the like. For another example, the interaction operation may be specifically a touch screen operation triggered when the interaction object performs interaction. The interaction location is a location at which the interaction operation is triggered. For example, when an interaction trigger operation is the click operation, the interaction location may be specifically a clicked location. For another example, when the interaction operation is a touch screen operation, the interaction location may be specifically a touched screen location.

The color value is a color value corresponding to a color in a color mode. For example, values corresponding to red in an RGB (red, green, blue) color mode are 255, 0, 0, values corresponding to green in the RGB color mode are 0, 255, 0, and values corresponding to blue in the RGB color mode are 0, 0, 255. In this embodiment, the color value may be specifically a color value corresponding to a color in a single-channel mode.

Specifically, when the virtual object exists in the virtual scene, if the interaction object wants to perform interaction, the interaction operation is triggered. In response to the interaction operation triggered in the virtual scene, the terminal may determine the interaction location indicated by the interaction operation, convert the interaction location indicated by the interaction operation into texture coordinates, perform color value identification according to the texture coordinates, to obtain a texture color value corresponding to the texture coordinates, and obtain the color value at the interaction location indicated by the interaction operation based on the texture color value.

Operation 204: Determine, from a pre-configured correspondence between a part of the virtual object and the color value according to the color value at the interaction location, a part of the virtual object matching the color value at the interaction location when the color value at the interaction location represents that the interaction operation acts on the virtual object, and obtain posture data of the virtual object, the posture data being configured for describing a posture of the virtual object.

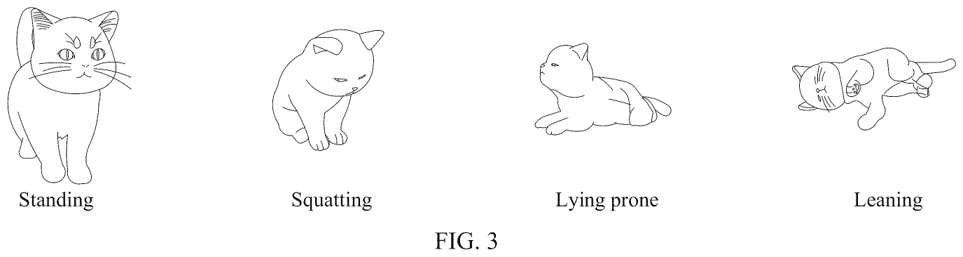

The posture data is configured for describing the posture of the virtual object. For example, the posture of the virtual object may be specifically one of standing, squatting, lying prone, leaning, and turning over. For example, when the virtual object is a virtual cat, possible postures may be shown in FIG. 3, and include standing, squatting, lying prone, and leaning.

Specifically, when the color value at the interaction location represents that the interaction operation acts on the virtual object, the terminal may determine, from the pre-configured correspondence between the part of the virtual object and the color value according to the color value at the interaction location, the part matching the color value at the interaction location, and obtain the posture data of the virtual object. The pre-configured correspondence between the part of the virtual object and the color value is a pre-configured mapping relationship between the part and the color value. Color values of different parts are different and may be configured according to an actual application scenario.

In a specific application, the terminal may determine, by comparing the color value at the interaction location with a color value threshold, whether the interaction operation acts on the virtual object. When the color value at the interaction location is greater than the color value threshold, it represents that the interaction operation acts on the virtual object. The color value threshold may be configured according to an actual application scenario. For example, the color value threshold may be specifically 0, which represents that when the color value at the interaction location is greater than 0, it is determined that the interaction operation acts on the virtual object. Because a part partition texture map includes color values of parts of the virtual object, and the color values of the parts are different, whether the interaction operation acts on the virtual object may be determined by using the color value at the interaction location as long as each of the color values of the parts is set to a value other than 0.

In a specific application, the virtual object may be specifically a virtual animal, for example, a virtual cat, and parts of the virtual object may be divided according to an actual application scenario. For example, the virtual object may be divided into six parts, namely, eyes, ears, a face, forepaws, a body, and a tail, and each part corresponds to a different color value. For example, the pre-configured correspondence between the part of the virtual object and the color value may be a color value 1 corresponding to the eyes, a color value 2 corresponding to the ears, a color value 3 corresponding to the face, a color value 4 corresponding to the forepaws, a color value 5 corresponding to the body, and a color value 6 corresponding to the tail. If the color value at the interaction location is the color value 3, according to the pre-configured correspondence between the part of the virtual object and the color value, it may be determined that the part matching the color value at the interaction location is the face.

Operation 206: Determine, based on a pre-configured mapping relationship among the posture of the virtual object, the part of the virtual object, and a feedback action type, a first feedback action type matching the posture data and the matching part.

The first feedback action type is a type of a feedback action matching the posture data and the matching part, and may be configured according to an actual application scenario. For example, the first feedback action type may be specifically a continuous feedback action. The continuous feedback action is a feedback action generated in response to continuously performing a continuous operation. For example, the continuous feedback action may be specifically a feedback action generated in response to a continuous sliding operation. For example, for a virtual pet, the continuous feedback action may be specifically a head-up action or a head-down action generated in response to the continuous sliding operation on the face. For another example, for the virtual pet, the continuous feedback action may be specifically a foot movement generated in response to the continuous sliding operation on the foot. A single feedback action is a feedback action that is performed only once, that is, a one-time feedback action. For example, the single feedback action may be specifically a posture change that is performed only once.

Specifically, for a same part, when postures of the virtual object are different, the first feedback action type matching the posture may be different. Therefore, when the posture data and the matching part are determined, the terminal may determine the posture of the virtual object according to the posture data, and then determine, based on the pre-configured mapping relationship among the posture of the virtual object, the part of the virtual object, and the feedback action type, the first feedback action type matching the posture data and the matching part. In a specific application, a mapping relationship among the posture of the virtual object, the part of the virtual object, and the feedback action type may be configured according to an actual application scenario. For example, when the posture is standing and the part is the face, the first feedback action type may be the continuous feedback action. For another example, when the posture is turning over and the part is the face, the first feedback action type may be the single feedback action.

Operation 208: Determine a calculation manner of a posture change parameter corresponding to the first feedback action type, and determine, based on the calculation manner of the posture change parameter, a posture change parameter of a feedback action of the first feedback action type relative to the matching part, the posture change parameter being a parameter configured for controlling the virtual object to perform a posture change.

The posture change parameter is the parameter configured for controlling the virtual object to perform a posture change. For example, the posture change parameter may be specifically an animation parameter configured for controlling the virtual object to perform a posture change.

Specifically, on the basis of determining the first feedback action type, the terminal needs to determine, according to the first feedback action type, the calculation manner of the posture change parameter corresponding to the first feedback action type, and determine, based on the calculation manner of the posture change parameter, the posture change parameter of the feedback action of the first feedback action type relative to the matching part. There are different calculation manners of the posture change parameter for different first feedback action types.

In a specific application, when the first feedback action type is the continuous feedback action, a calculation manner corresponding to the posture change parameter may be: using the interaction operation as a start trigger operation of the continuous operation corresponding to the continuous feedback action, and starting from the start trigger operation, determining, in response to the continuous operation, the posture change parameter corresponding to the continuous operation and the matching part. When the first feedback action type is the single feedback action, a calculation manner corresponding to the posture change parameter may be: obtaining a feedback action sequence corresponding to the matching part, to determine the posture change parameter based on the feedback action sequence. In a specific application, the continuous operation includes a plurality of trigger operations. For each trigger operation in the continuous operation, the terminal needs to determine the posture change parameter corresponding to the trigger operation and the matching part.

Operation 210: Control, based on the posture change parameter, the virtual object to perform a feedback action corresponding to the matching part.

Specifically, the terminal controls, based on the posture change parameter, the virtual object to perform the feedback action corresponding to the matching part. In a specific application, the posture change parameter may be specifically the animation parameter, and controlling the virtual object to perform the feedback action corresponding to the matching part may be understood as that the terminal implements an animation corresponding to the animation parameter.

In a specific application, for the continuous feedback action, the determined posture change parameter is a posture change parameter corresponding to each trigger operation in the continuous operation corresponding to the continuous feedback action. Therefore, when controlling, based on the posture change parameter, the virtual object to perform the feedback action corresponding to the matching part, for each trigger operation, the terminal controls, based on the trigger operation, the virtual object to perform the feedback action corresponding to the trigger operation and the matching part.

In a specific application, for the single feedback action, the determined posture change parameter is a posture change parameter of the single feedback action, and the terminal directly controls, based on the posture change parameter of the single feedback action, the virtual object to perform the feedback action corresponding to the matching part.

In a specific application, it is assumed that the virtual object is the virtual pet, the matching part is the ear, the first feedback action type matching the posture data and the matching part is the single feedback action, and the feedback action is that ears shake once, the terminal may obtain an animation parameter configured for implementing the ears to shake once, and control, according to the animation parameter, the virtual pet to perform the feedback action of shaking ears once corresponding to the ear.

According to the foregoing virtual object interaction method, when the virtual object exists in the virtual scene, in response to the interaction operation triggered in the virtual scene, the color value at the interaction location indicated by the interaction operation is identified, and when the color value at the interaction location represents that the interaction operation acts on the virtual object, the part of the virtual object matching the color value of the interaction location is determined from the pre-configured correspondence between the part of the virtual object and the color value according to the color value at the interaction location. The matching part that needs interaction can be determined in a color value partition identification manner. The posture data of the virtual object is obtained, so that the posture data and the matching part can be combined. The first feedback action type is determined based on the pre-configured mapping relationship among the posture of the virtual object, the part of the virtual object, and the feedback action type. Further, on the basis of determining the first feedback action type, the calculation manner of the posture change parameter corresponding to the first feedback action type may be determined. The posture change parameter of the feedback action relative to the matching part is determined based on the calculation manner of the posture change parameter, so that the virtual object may be controlled, based on the posture change parameter, to perform the feedback action corresponding to the matching part. In an entire process, on the basis of determining the matching part by using the color value, diversified feedback on the virtual object can be achieved with reference to the matching part, the posture data, the first feedback action type, and the like, and resources of the virtual object can be fully utilized, thereby improving resource utilization.

In an embodiment, the identifying, in response to an interaction operation triggered in a virtual scene when a virtual object exists in the virtual scene, a color value at an interaction location indicated by the interaction operation includes:
converting, when the virtual object exists in the virtual scene, in response to the interaction operation triggered in the virtual scene, the interaction location indicated by the interaction operation into first texture coordinates, and rendering a color texture map onto a pre-configured screen render texture map, the color texture map being a texture map obtained by rendering the virtual object based on a part partition texture map, and the part partition texture map including color values of parts of the virtual object;
performing, according to the first texture coordinates, texture sampling on the screen render texture map on which the color texture map has been rendered, to obtain a texture color value corresponding to the first texture coordinates; and
determining the color value at the interaction location indicated by the interaction operation based on the texture color value.

The texture coordinates are UV coordinates, and are configured for indicating a location on a texture image from which sampling is performed, that is, from which pixel colors are collected. U is a horizontal direction, and V is a vertical direction. The texture coordinates may be understood as percentage coordinates on the texture image. The texture coordinates range from 0 to 1. Generally, UV(0, 0) is an upper left corner of the texture image, and UV(1, 1) is a lower right corner of the texture image.

The color texture map is the texture map obtained by rendering the virtual object based on the part partition texture map. The part partition texture map is a model map configured for drawing a surface texture of the virtual object. Each pixel in the part partition texture map corresponds to a surface of the virtual object. In this embodiment, the part partition texture map includes color values of parts of the virtual object, and the color values of the parts are different. In other words, in the part partition texture map, the color values of pixels belonging to the same part are the same, and the color values of pixels belonging to different parts are different. In this manner, different parts of the virtual object can be distinguished by using the color value.

The screen render texture map is a texture type, may also be referred to as RenderTexture, and is a special texture type in Unity (a real-time 3D interaction content creation and operation platform). The screen render texture map defines a server-side texture object. Directly rendering information onto this texture is equivalent to that the information is directly drawn during drawing of the texture. In this way, copying time may be saved. The texture sampling is a process of obtaining a color at a corresponding location from a texture map according to the texture coordinates. In this embodiment, the texture sampling is a process of obtaining a color at a corresponding location from the screen render texture map according to the first texture coordinates.

Specifically, when the virtual object exists in the virtual scene, in response to the interaction operation triggered in the virtual scene, the terminal determines the interaction location indicated by the interaction operation, converts the interaction location indicated by the interaction operation into the first texture coordinates, and renders the color texture map onto the pre-configured screen render texture map. The terminal maps the first texture coordinates to corresponding pixel coordinates on the screen render texture map according to a size of the screen render texture map, uses a pixel value at the pixel coordinates as a texture color value corresponding to the first texture coordinates, and then determines the color value at the interaction location indicated by the interaction operation based on the texture color value.

In a specific application, when the virtual scene in which the virtual object exists is entered, the terminal obtains a part partition texture map corresponding to the virtual object, sets the part partition texture map to a rendering material corresponding to the virtual object, and renders the virtual object based on the rendering material, to obtain the color texture map. The part partition texture map includes color values of parts of the virtual object, and the color values of the parts are different. The rendering material is information for describing surface appearance of the virtual object, including appearance, a color, texture, smoothness, transparency, and the like, and is essentially an example of a shader.

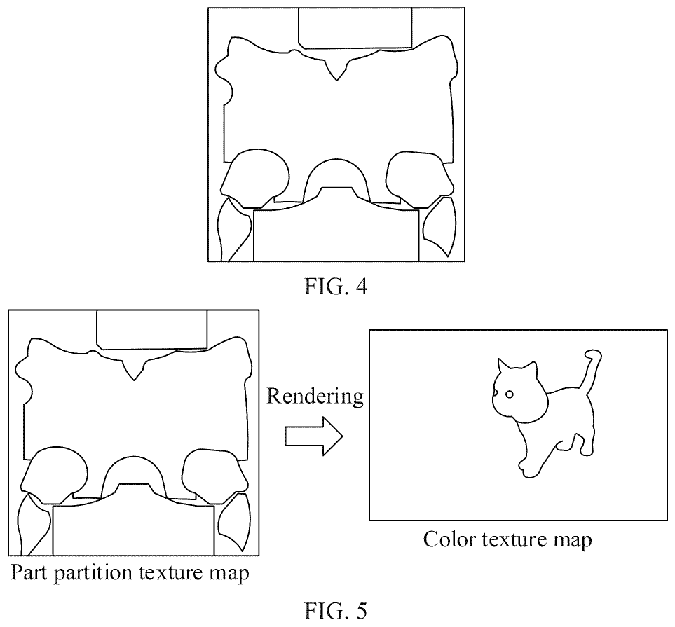

In a specific application, a part partition manner for the virtual object may be configured according to an actual application scenario. For example, the virtual object may be specifically the virtual animal, such as the virtual cat, and may be divided into six parts: eyes, ears, a face, forepaws, a body, and a tail. A part partition texture map corresponding to the virtual cat may be shown in FIG. 4. A color texture map obtained by rendering the virtual cat based on the part partition texture map may be shown in FIG. 5 (a color value of a part is not shown in FIG. 5).

In a specific application, in the part partition texture map, color values of parts may be configured according to an actual application scenario. In a specific application, a smaller and more important part indicates that a color value is larger, so that the importance of the part may be divided by using the color value as a priority. For example, for smaller and important parts such as eyes and ears, color values thereof may be greater than those of parts such as a face and a body during configuration.

In a specific application, the terminal may invoke a rendering interface to render the color texture map to the pre-configured screen render texture map. In a specific application, the invoked rendering interface may be specifically a command buffer, which is an encapsulated rendering interface newly added by Unity. A most important function is that a series of rendering instructions may be pre-defined, and then the rendering instructions are executed at a desired moment. That is, the rendering instructions may be executed when the rendering interface is invoked.

In a specific application, it is assumed that the size of the screen render texture map is X*Y, and the first texture coordinates are (U, V)=(A1, B1), corresponding pixel coordinates obtained by mapping the first texture coordinates to the screen render texture map are (A1*X, B1*Y). For example, it is assumed that the size of the screen render texture map is 256*256, and the first texture coordinates are (U, V)=(0.5, 0.5), corresponding pixel coordinates obtained by mapping the first texture coordinates to the screen render texture map are (128, 128). In a specific application, the terminal directly uses the texture color value as the color value at the interaction location indicated by the interaction operation. In this manner, complex calculation is avoided, and the color value at the interaction location indicated by the interaction operation can be quickly determined.

In a specific application, the terminal obtains a color value selection range of the interaction location indicated by the interaction operation, and the color value selection range may be pre-configured according to an actual application scenario. When the color value selection range is obtained, the terminal obtains, from the screen render texture map based on the color value selection range, at least one candidate color value corresponding to the color value selection range, performs color value comparison on the at least one candidate color value and the texture color value, and obtains the color value at the interaction location indicated by the interaction operation according to a comparison result.

In a specific application, for each candidate color value in the at least one candidate color value, the candidate color value may be the same as the texture color value, or may be different from the texture color value. If the candidate color value and the texture color value correspond to the same part, the candidate color value and the texture color value have the same value. If the candidate color value and the texture color value correspond to different parts, the candidate color value and the texture color value have different values. Color value comparison is performed on the at least one candidate color value and the texture color value, a maximum color value in the at least one candidate color value and the texture color value may be determined according to the comparison result, or a color value having a largest quantity of times of occurrence, that is, a color value mode, in the at least one candidate color value and the texture color value may be determined. The terminal may use the maximum color value in the at least one candidate color value and the texture color value as the color value at the interaction location indicated by the interaction operation, or may use the color value having the largest quantity of times of occurrence, that is, the color value mode, in the at least one candidate color value and the texture color value as the color value at the interaction location indicated by the interaction operation.

In this embodiment, in response to the interaction operation triggered in the virtual scene, the interaction location indicated by the interaction operation is converted into the first texture coordinates, the color texture map is rendered onto the pre-configured screen render texture map, and texture sampling is performed, according to the first texture coordinates, on the screen render texture map on which the color texture map has been rendered, so that the texture color value corresponding to the first texture coordinates can be obtained, thereby determining the color value at the interaction location indicated by the interaction operation based on the texture color value, and achieving accurate color value identification.

In an embodiment, the virtual object interaction method further includes:
triggering an accumulated feedback event when accumulated interaction time corresponding to the matching part satisfies a first accumulated feedback trigger condition; and
controlling, in response to the accumulated feedback event, the virtual object to perform a feedback action mapped to the accumulated feedback event corresponding to the matching part.

The accumulated interaction time is time for which the interaction has been performed for the matching part. The first accumulated feedback trigger condition is a condition that is configured for triggering the accumulated feedback event and that is determined based on the accumulated interaction time, and may be configured according to an actual application scenario. For example, the first accumulated feedback trigger condition may be specifically that the accumulated interaction time reaches pre-configured time. The pre-configured time may be configured according to an actual application scenario. The accumulated feedback event is an event that provides feedback on the accumulated interaction.

Specifically, the terminal collects statistics on the accumulated interaction time corresponding to the matching part. When the accumulated interaction time corresponding to the matching part satisfies the first accumulated feedback trigger condition, the terminal triggers the accumulated feedback event, and in response to the accumulated feedback event, controls the virtual object to perform the feedback action mapped to the accumulated feedback event corresponding to the matching part, to achieve feedback on the accumulated interaction. In a specific application, for different parts, feedback actions mapped to accumulated feedback events corresponding to different parts may be configured according to an actual application scenario. For example, when the matching part is the body, the feedback action mapped to the accumulated feedback event corresponding to the matching part may be rolling on the ground.

In this embodiment, when the accumulated interaction time corresponding to the matching part satisfies the first accumulated feedback trigger condition, the accumulated feedback event can be triggered, so that the virtual object is controlled, in response to the accumulated feedback event, to perform the feedback action mapped to the accumulated feedback event corresponding to the matching part, to achieve feedback on the accumulated interaction, and to fully utilize resources of the virtual object, thereby improving resource utilization, and also providing abundant simulated interaction experience for the interaction object.

In an embodiment, the virtual object interaction method further includes:
triggering an accumulated feedback event when an accumulated quantity of times of interaction corresponding to the matching part satisfies a second accumulated feedback trigger condition; and
controlling, in response to the accumulated feedback event, the virtual object to perform a feedback action mapped to the accumulated feedback event corresponding to the matching part.

The accumulated quantity of times of interaction is a quantity of times of interaction for the matching part. The second accumulated feedback trigger condition is a condition configured for triggering the accumulated feedback event based on the accumulated quantity of times of interaction, and may be configured according to an actual application scenario. For example, the second accumulated feedback trigger condition may be specifically that the accumulated quantity of times of interaction reaches a pre-configured quantity of times. The pre-configured quantity of times may be configured according to an actual application scenario. The accumulated feedback event is an event that provides feedback on the accumulated interaction.

Specifically, the terminal collects statistics on the accumulated quantity of times of interaction corresponding to the matching part. When the accumulated quantity of times of interaction corresponding to the matching part satisfies the second accumulated feedback trigger condition, the terminal triggers the accumulated feedback event, and controls, in response to the accumulated feedback event, the virtual object to perform the feedback action mapped to the accumulated feedback event corresponding to the matching part, to achieve feedback on the accumulated interaction. In a specific application, for different parts, feedback actions mapped to accumulated feedback events corresponding to different parts may be configured according to an actual application scenario. For example, when the matching part is the body, the feedback action mapped to the accumulated feedback event corresponding to the matching part may be rolling on the ground.

In this embodiment, when the accumulated interaction time corresponding to the matching part or the accumulated quantity of times of interaction satisfies a corresponding accumulated feedback trigger condition, the accumulated feedback event can be triggered, so that the virtual object is controlled, in response to the accumulated feedback event, to perform the feedback action mapped to the accumulated feedback event corresponding to the matching part, to achieve feedback on the accumulated interaction, and to fully utilize resources of the virtual object, thereby improving resource utilization, and also providing abundant simulated interaction experience for the interaction object.

In an embodiment, the determining a calculation manner of a posture change parameter corresponding to the first feedback action type, and determining, based on the calculation manner of the posture change parameter, a posture change parameter of a feedback action of the first feedback action type relative to the matching part includes:
using, when the first feedback action type is a continuous feedback action, the interaction operation as a start trigger operation of a continuous operation corresponding to the continuous feedback action; and
starting from the start trigger operation, determining, in response to each trigger operation in the continuous operation, a posture change parameter corresponding to the trigger operation and the matching part.

The continuous feedback action is a feedback action generated in response to continuously performing a continuous operation, and the continuous operation is an operation generated in a process in which the interaction object performs continuous interaction on the virtual object. For example, the continuous feedback action may be specifically a feedback action generated in response to a continuous sliding operation. The trigger operation is an operation that is detected in a process in which the interaction object performs the continuous operation and that can trigger a posture change of the virtual object.

Specifically, when the first feedback action type is the continuous feedback action, representing that the interaction object may perform continuous interaction with the virtual object, the terminal uses the interaction operation as the start trigger operation of the continuous operation corresponding to the continuous feedback action, and starting from the start trigger operation, determine, in response to each trigger operation in the continuous operation, the posture change parameter corresponding to the trigger operation and the matching part.

In a specific application, when the first feedback action type is the continuous feedback action, the terminal performs trigger operation identification on each frame of the virtual scene in a process of the continuous operation, to determine each trigger operation in the continuous operation. That is, for each frame of the virtual scene in a process of the continuous operation, the terminal determines a trigger operation corresponding to a virtual scene. The trigger operation corresponding to the virtual scene is an operation triggered when the interaction object performs continuous interaction when the virtual scene is displayed. For example, the trigger operation corresponding to the virtual scene may be specifically a touch screen operation triggered when the interaction object performs continuous interaction when the virtual scene is displayed.

In this embodiment, the interaction operation is used as the start trigger operation of the continuous operation corresponding to the continuous feedback action, and starting from the start trigger operation, in response to each trigger operation in the continuous operations, the posture change parameter corresponding to the trigger operation and the matching part is determined, so that the posture change parameter corresponding to the continuous feedback action can be determined.

In an embodiment, the determining a posture change parameter corresponding to the trigger operation and the matching part includes:
converting a trigger location indicated by the trigger operation into second texture coordinates, performing, according to the second texture coordinates, texture sampling on the screen render texture map on which the color texture map has been rendered, and determining a color value at the trigger location indicated by the trigger operation; and
determining a posture change parameter corresponding to the color value at the trigger location and the matching part.

Specifically, the terminal converts the trigger location indicated by the trigger operation into the second texture coordinates, renders the color texture map corresponding to the trigger operation onto the pre-configured screen render texture map, performs, according to the second texture coordinates, texture sampling on the screen render texture map on which the color texture map has been rendered, determines the color value at the trigger location indicated by the trigger operation, and then determines the posture change parameter corresponding to the color value at the trigger location and the matching part.

In a specific application, on the basis of determining the color value at the trigger location indicated by the trigger operation, the terminal determines, based on the color value at the trigger location indicated by the trigger operation, whether the trigger operation acts on the virtual object. If the trigger operation acts on the virtual object, the terminal determines, based on the pre-configured correspondence between the part of the virtual object and the color value, a part corresponding to the color value at the trigger location, performs posture parameter calculation based on the part corresponding to the color value at the trigger location and the matching part, and determines the posture change parameter corresponding to the color value at the trigger location and the matching part.

In a specific application, if the trigger operation does not act on the virtual object, representing that the trigger operation acts on a background region in the virtual scene, the terminal may further determine whether the trigger operation satisfies a virtual scene lens switching interaction condition. If the trigger operation does not satisfy the virtual scene lens switching interaction condition, the terminal uses a posture control parameter corresponding to the matching part as the posture change parameter. If the trigger operation satisfies the virtual scene lens switching interaction condition, the terminal determines that an interaction manner corresponding to the color value at the trigger location indicated by the trigger operation is virtual scene lens switching interaction, and uses a virtual scene lens switching direction mapped to the trigger location as the posture change parameter.

In a specific application, the virtual scene lens switching interaction condition may be configured according to an actual application scenario. For example, the virtual scene lens switching interaction condition may be specifically that none of trigger operations lasting for N seconds before a trigger operation in the continuous operation acts on the virtual object. N may be configured according to an actual application scenario.

In this embodiment, the color value at the trigger location indicated by the trigger operation is first determined, so that the posture change parameter can be determined by using the determined color value and the matching part.

In an embodiment, the determining a posture change parameter corresponding to the color value at the trigger location and the matching part includes:
performing, when a part corresponding to the color value at the trigger location is the same as the matching part, posture change parameter calculation based on the trigger location and the matching part, to obtain the posture change parameter.

Specifically, when the trigger operation acts on the virtual object, the terminal determines the part corresponding to the color value at the trigger location based on the pre-configured correspondence between the part of the virtual object and the color value. When the part corresponding to the color value at the trigger location is the same as the matching part, it represents that the trigger operation acts on the matching part, and the terminal directly performs posture change parameter calculation based on the trigger location and the matching part, to obtain the posture change parameter.

In a specific application, for different parts, a type of the posture change parameter for controlling the virtual object to perform the feedback action corresponding to the part may be different. Therefore, for different parts, the terminal performs posture change parameter calculation based on the trigger location in different manners, to obtain the posture change parameter. In a specific application, for the face, the virtual object may be controlled to perform a feedback action corresponding to the face by using an animation parameter of the face. Therefore, if the matching part is the face, the terminal needs to calculate the animation parameter corresponding to the face based on the trigger location. For the foot, the virtual object may be controlled to perform a feedback action corresponding to the foot by using a bone point movement location obtained based on inverse kinematics. Therefore, if the matching part is the foot, the terminal needs to calculate, based on the trigger location, a foot bone point movement location of a bone point of a foot and a parent bone point movement location of each level of parent bone points on a bone point at which the bone point of the foot is located.

In this embodiment, when the part corresponding to the color value at the trigger location is the same as the matching part, posture change parameter calculation can be performed based on the trigger location and the matching part, to determine the posture change parameter.

In an embodiment, the matching part is a face; and the performing posture change parameter calculation based on the trigger location and the matching part, to obtain the posture change parameter includes:
obtaining a screen range of the face of the virtual object and a screen location of a facial central bone point;
determining a location offset between the screen location and the trigger location;
determining, based on the location offset and a facial animation parameter range corresponding to the screen range, an animation parameter corresponding to the trigger location within the facial animation parameter range; and
obtaining the posture change parameter based on the animation parameter corresponding to the trigger location.

The screen range is an approximate range of the face of the virtual object on a terminal screen. The facial central bone point is a screen location of a bone point used as a center of the face, and the center of the face may be configured according to an actual application scenario. For example, the center of the face may be a specific part in the face. For example, the center of the face may be specifically a nose, eyes, a mouth, or the like in the face. The facial animation parameter range is a range of an animation parameter configured for controlling the virtual object to perform the feedback action corresponding to the face, and may be configured according to an actual application scenario.

Specifically, the terminal obtains a focal length of a virtual camera in the virtual scene, obtains the screen range of the face of the virtual object by using the focal length of the virtual camera, obtains a screen location of the facial central bone point according to a relationship between the bone point of the virtual object and screen coordinates, determines the location offset between the screen location and the trigger location, positions the trigger location in the facial animation parameter range according to the location offset, determines the animation parameter corresponding to the trigger location within the facial animation parameter range, and then obtains the posture change parameter based on the animation parameter corresponding to the trigger location.

In a specific application, the focal length of the virtual camera in the virtual scene may be directly obtained by using a pre-configured focal length obtaining function. Obtaining the screen range of the face of the virtual object may be understood as obtaining a size of a frustum at a certain distance from the virtual camera. When the focal length is obtained, the screen range of the face of the virtual object may be directly calculated by using a pre-configured screen range calculation function. The pre-configured screen range calculation function may be configured according to an actual application scenario, and is not limited herein in this embodiment. Because the virtual camera corresponding to the virtual scene not only can be rotated by 360 degrees, but also can be zoomed in or zoomed out, and screen ranges of the face at different focal lengths are inconsistent, the focal length needs to be first obtained, and then the screen range of the face is obtained by using the focal length, so as to accurately determine the facial animation parameter range.

In this embodiment, the location offset between the screen location and the trigger location is determined by obtaining the screen range of the face of the virtual object and the screen location of the facial central bone point. The animation parameter corresponding to the trigger location can be determined by using the location offset and the facial animation parameter range corresponding to the screen range, so that the posture change parameter can be determined by using the animation parameter corresponding to the trigger location.

In an embodiment, the animation parameter corresponding to the trigger location includes a horizontal direction control parameter and a vertical direction control parameter; and the obtaining the posture change parameter based on the animation parameter corresponding to the trigger location includes:
obtaining a vertical direction initial parameter of the face, and performing smoothing interpolation between the vertical direction initial parameter and the vertical direction control parameter, to obtain an interpolated vertical direction control parameter; and
using the horizontal direction control parameter and the interpolated vertical direction control parameter as the posture change parameters.

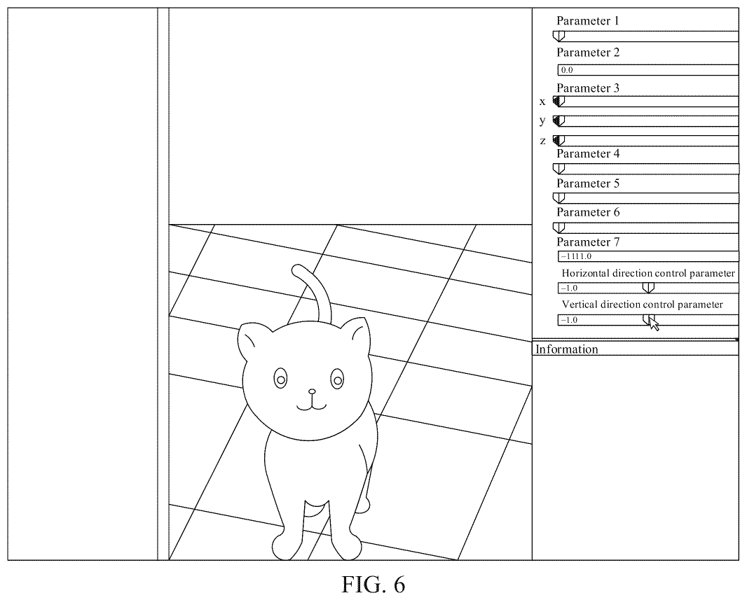

As shown in FIG. 6, to simulate real feedback of the virtual object touching its head and scratching its chin in the real world as much as possible, degrees of horizontal and up-and-down rotation of the face of the virtual object may be separately controlled by using two parameters, the horizontal direction control parameter and the vertical direction control parameter. The two parameters are combined to implement 360-degree rotation of the face of the virtual object within a certain range. Further, as shown in FIG. 6, in addition to the two parameters, the horizontal direction control parameter and the vertical direction control parameter, the virtual object may further be controlled, by using other parameters (including a parameter 1, a parameter 2, a parameter 3, a parameter 4, a parameter 5, a parameter 6, and a parameter 7 as shown in FIG. 6), to perform the feedback action. The vertical direction initial parameter of the face is a parameter that controls the degree of up-and-down rotation of the face of the virtual object before the trigger operation is triggered.

Specifically, the terminal obtains the vertical direction initial parameter of the face, performs smoothing interpolation between the vertical direction initial parameter and the vertical direction control parameter, to obtain the interpolated vertical direction control parameter, so that the vertical direction initial parameter can smoothly transition to the vertical direction control parameter, and uses the horizontal direction control parameter and the interpolated vertical direction control parameter as the posture change parameters. In a specific application, smoothing interpolation may be performed between the vertical direction initial parameter and the vertical direction control parameter by using a smoothdamp function, to obtain the interpolated vertical direction control parameter. The smoothdamp function is a spring damping effect, and may further limit a maximum change speed. Through this interpolation manner, the damping effect can be increased, so that up-and-down rotation of the face of the virtual object is smoother and more natural.

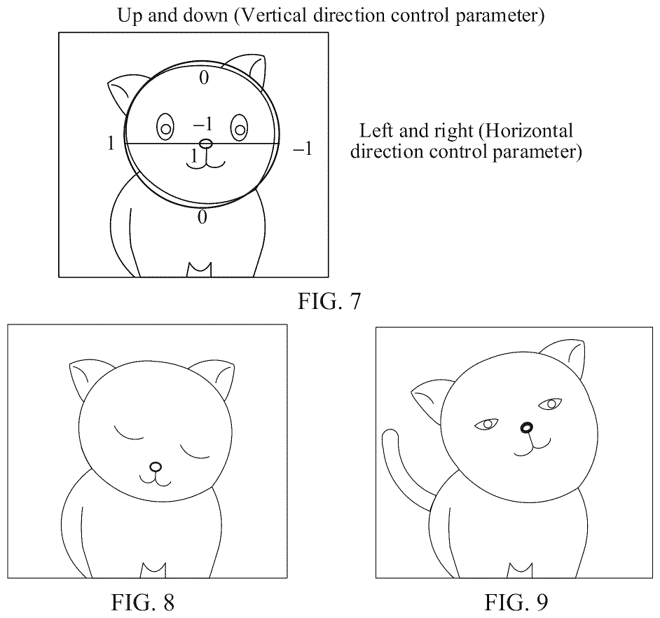

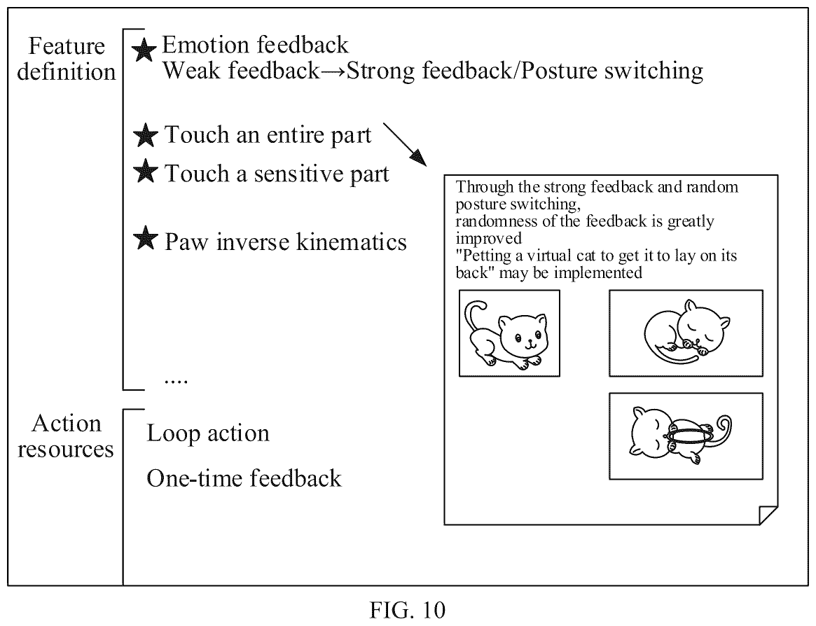

In a specific application, an example in which the virtual object is the virtual cat and a nose is used as the center of the face of the virtual cat is used to describe an effect of this interpolation manner. A configured facial animation parameter range can be shown in FIG. 7. The nose used as the center of the face is used as a boundary to control the virtual cat to shake left and right, and a range of a horizontal direction control parameter of the virtual cat is [−1 1]. When the virtual cat is controlled to shake up and down, as shown in FIG. 8, because when a head of the virtual cat is petted, the virtual cat lowers its head and shakes within a range, as shown in FIG. 9, when a chin of the virtual cat is petted, the virtual cat raises its head and shakes, and the vertical direction control parameter may be roughly divided into an upper half region and a lower half region. The vertical direction control parameter from the head to the nose in the upper half region ranges from [0 −1], and the vertical direction control parameter from the nose to the chin in the lower half region ranges from [1 0]. It can be learned from FIG. 7 that a sudden change occurs in the vertical direction control parameter at the nose. Smoothing interpolation is performed between the vertical direction initial parameter and the vertical direction control parameter, to obtain the interpolated vertical direction control parameter. The interpolated vertical direction control parameter is used to control up-and-down rotation of the face of the virtual object, which is equivalent to performing short-time animation mixing when switching is performed in the upper half region and the lower half region. This can increase the damping effect, and make the up-and-down rotation of the face of the virtual object smoother and more natural.

In this embodiment, through this interpolation manner, the horizontal direction control parameter and the interpolated vertical direction control parameter are used as the posture change parameters, to increase the damping effect, so that rotation of the face of the virtual object is smoother and more natural.

In an embodiment, the matching part is a foot; and the performing posture change parameter calculation based on the trigger location and the matching part, to obtain the posture change parameter includes:
obtaining a plane in which the virtual object is located, the plane in which the virtual object is located being obtained based on a world location of a bone point of a foot and an orientation axis of the virtual object;
determining a plane intersection point of the trigger location relative to the plane in which the virtual object is located, and using the plane intersection point as a foot bone point movement location of the bone point of the foot; and
performing bone point movement deduction based on the foot bone point movement location, to obtain the posture change parameter.

The world location of the bone point of the foot is a location of the bone point of the foot in a world coordinate system. The orientation axis of the virtual object is configured for representing an orientation of the virtual object.

Specifically, when the matching part is the foot, the terminal obtains the plane in which the virtual object is located, and draws a ray from the trigger location, so that the ray drawn from the trigger location intersects with the plane in which the virtual object is located, uses the intersection point as the plane intersection point of the trigger location relative to the plane in which the virtual object is located, uses the plane intersection point as the foot bone point movement location of the bone point of the foot, and then performs bone point movement deduction based on the foot bone point movement location in a reverse deduction manner, to obtain the posture change parameter.

In a specific application, the plane in which the virtual object is located is obtained based on the world location of the bone point of the foot and the orientation axis of the virtual object. If the trigger operation is the start trigger operation, the terminal needs to obtain the world location of the bone point of the foot and the orientation axis of the virtual object to calculate the plane in which the virtual object is located. If the trigger operation is not the start trigger operation, the terminal directly obtains the plane in which the virtual object is located calculated at the start trigger operation.

In a specific application, each bone point of the virtual object has a corresponding world location and identifier, which is determined when the virtual object is constructed. The terminal may directly obtain the world location of the bone point of the foot according to the identifier of the bone point of the foot. The orientation axis of the virtual object may be obtained by using a pre-configured orientation axis obtaining function. After the world location of the bone point of the foot and the orientation axis of the virtual object are obtained, the plane in which the virtual object is located may be determined based on the world location of the bone point of the foot and the orientation axis. The world location of the bone point of the foot is on the plane in which the virtual object is located, and the orientation axis is consistent with a direction of the plane in which the virtual object is located.

In this embodiment, the plane intersection point of the trigger location relative to the plane in which the virtual object is located is determined by obtaining the plane in which the virtual object is located based on the world location of the bone point of the foot and the orientation axis of the virtual object, and the plane intersection point is used as the foot bone point movement location of the bone point of the foot, so that the foot bone point movement location can be determined, and bone point movement deduction is performed based on the foot bone point movement location, to determine the posture change parameter.

In an embodiment, the performing bone point movement deduction based on the foot bone point movement location, to obtain the posture change parameter includes:
performing bone point movement deduction based on the foot bone point movement location when the foot bone point movement location is within an interaction range of the foot, to obtain a parent bone point movement location of each level of parent bone points on a bone chain in which the bone point of the foot is located; and
obtaining the posture change parameter based on the foot bone point movement location and the parent bone point movement location.

Specifically, after determining the foot bone point movement location, the terminal determines whether the foot bone point movement location is within the interaction range of the foot. When the foot bone point movement location is within the interaction range of the foot, the terminal performs bone point movement deduction based on the foot bone point movement location by using inverse kinematics, that is, reverse deduction, to obtain the parent bone point movement location of each level of parent bone points on the bone chain in which the bone point of the foot is located, and then obtains the posture change parameter based on the foot bone point movement location and the parent bone point movement location. Inverse kinematics is a method of determining an entire bone chain by first determining a location of a child bone, and then reversely deducting a location of n-level of parent bones in a bone chain in which the child bone is located.

In a specific application, foot interaction is performed only when the foot bone point movement location is within the interaction range of the foot, and foot interaction is exited if the foot bone point movement location is not within the interaction range of the foot. In a specific application, the interaction range may be configured according to an actual application scenario. For example, the interaction range may be specifically a certain range of an interaction radius in which a location obtained by offsetting the world location of the bone point of the foot by a preset distance as a center of an interaction circle. The preset distance may be configured according to an actual application scenario, and the interaction radius may also be configured according to an actual application scenario, and is positively correlated to a size of the virtual object. A larger virtual object indicates a larger interaction radius, and a smaller virtual object indicates a smaller interaction radius.

In this embodiment, when the foot bone point movement location is within the interaction range of the foot, bone point movement deduction is performed based on the foot bone point movement location, so that the parent bone point movement location of each level of parent bone points on the bone chain in which the bone point of the foot is located can be obtained, thereby determining the posture change parameter based on the foot bone point movement location and the parent bone point movement location.

In an embodiment, the obtaining the posture change parameter based on the foot bone point movement location and the parent bone point movement location includes:
determining, based on a location of the bone point of the foot before moving and the foot bone point movement location, a foot movement control parameter that controls movement of the bone point of the foot; and
using the foot movement control parameter and the parent bone point movement location as the posture change parameters.

Specifically, the location of the bone point of the foot before moving is a location of the bone point of the foot when the trigger operation is triggered. The terminal may determine, based on the location of the bone point of the foot before moving and the foot bone point movement location, the foot movement control parameter configured for controlling movement of the bone point of the foot, and further use the foot movement control parameter and the parent bone point movement location as the posture change parameters.

In a specific application, the foot movement control parameter is configured for slowly accumulating movement of the bone point of the foot from a location before moving to the foot bone point movement location, which is equivalent to a smooth damping effect, and making the movement of the foot look more natural. In a specific application, the foot movement control parameter may be obtained by performing smoothing interpolation between the location before moving and the foot bone point movement location.

In this embodiment, based on the location of the bone point of the foot before moving and the foot bone point movement location, the foot movement control parameter for controlling movement of the bone point of the foot can be determined, so that the foot movement control parameter and the parent bone point movement location can be used as the posture change parameters, to determine the posture change parameter.

In an embodiment, the determining a posture change parameter corresponding to the color value at the trigger location and the matching part includes:
determining, when a part corresponding to the color value at the trigger location is different from the matching part and the part corresponding to the color value at the trigger location satisfies an interaction part update condition, the part corresponding to the color value at the trigger location as an interaction part, and obtaining an interaction posture of the virtual object corresponding to a moment at which the trigger operation is triggered; and
performing posture change parameter calculation based on the interaction part and the interaction posture, to obtain the posture change parameter.

The interaction part update condition is a condition for updating the interaction part, and may be configured according to an actual application scenario. For example, the interaction part update condition may be specifically that trigger operations lasting for M seconds before the trigger operation in the continuous operation all act on the part corresponding to the color value at the trigger location. M may be configured according to an actual application scenario. For example, M may be 0.2 or 0.3.

Specifically, when the trigger operation acts on the virtual object, the terminal determines the part corresponding to the color value at the trigger location based on the pre-configured correspondence between the part of the virtual object and the color value. When the part corresponding to the color value at the trigger location is different from the matching part, it represents that the trigger operation may not be performed on the matching part, or may be performed on the matching part, that is, there is an accidental touch. In this case, the terminal needs to further determine whether the part corresponding to the color value at the trigger location satisfies the interaction part update condition. If the part corresponding to the color value at the trigger location satisfies the interaction part update condition, the terminal determines the part corresponding to the color value at the trigger location as the interaction part, obtains the interaction posture of the virtual object corresponding to a moment at which the trigger operation is triggered, and performs posture change parameter calculation based on the interaction part and the interaction posture, to obtain the posture change parameter. In a specific application, the terminal first determines a second feedback action type matching the interaction posture and the interaction part, and then determines a posture change parameter that is of a feedback action of the second feedback action type and that is relative to the interaction part.

In this embodiment, when the part corresponding to the color value at the trigger location is different from the matching part and the part corresponding to the color value at the trigger location satisfies the interaction part update condition, the part corresponding to the color value at the trigger location may be directly determined as the interaction part, so that on the basis of obtaining the interaction posture of the virtual object corresponding to a moment at which the trigger operation is triggered, posture change parameter calculation may be performed based on the interaction part and the interaction posture, to determine the posture change parameter.

In an embodiment, the determining a posture change parameter corresponding to the color value at the trigger location and the matching part includes:
using, when a part corresponding to the color value at the trigger location is different from the matching part and the part corresponding to the trigger location does not satisfy an interaction part update condition, a posture control parameter corresponding to the matching part as the posture change parameter.

Specifically, when the trigger operation acts on the virtual object, the terminal determines the part corresponding to the color value at the trigger location based on the pre-configured correspondence between the part of the virtual object and the color value. When the part corresponding to the color value at the trigger location is different from the matching part, it represents that the trigger operation may not be performed on the matching part, or may be performed on the matching part, that is, there is an accidental touch. In this case, the terminal needs to further determine whether the part corresponding to the color value at the trigger location satisfies the interaction part update condition. If the part corresponding to the color value at the trigger location does not satisfy the interaction part update condition, it represents that there is an accidental touch, and the terminal uses the posture control parameter corresponding to the matching part as the posture change parameter. The posture control parameter is a parameter configured for controlling a posture change.

In a specific application, for different parts, posture control parameters corresponding to the different parts are different, and the posture control parameters corresponding to the different parts may be configured according to an actual application scenario. For example, for the face, a posture control parameter corresponding to the face may be a pre-configured animation parameter, that is, a corresponding posture change is pre-configured facial shaking. For another example, for the foot, a posture control parameter corresponding to the foot may be specifically determined by a foot movement control parameter of a previous trigger operation corresponding to the trigger operation. Corresponding to the foot movement control parameter, the posture control parameter is configured for slowing down movement of the bone point of the foot from the foot bone point movement location to a location before moving, which is equivalent to a smooth damping effect, and making the movement of the foot look more natural when the foot interaction is exited. In a specific application, it is assumed that the foot movement control parameter is: Parameter 1-Parameter 2-Parameter 3-Parameter 4, for controlling movement of the bone point of the foot from a location before moving to the foot bone point movement location, and a posture control parameter corresponding to the foot movement control parameter may be Parameter 4-Parameter 3-Parameter 2-Parameter 1, for controlling movement of the bone point of the foot from the foot bone point movement location to a location before moving.

In this embodiment, when the part corresponding to the color value at the trigger location is different from the matching part and the part corresponding to the trigger location does not satisfy the interaction part update condition, the posture control parameter corresponding to the matching part is directly used as the posture change parameter, so that the posture change parameter can be determined.

In an embodiment, the determining a calculation manner of a posture change parameter corresponding to the first feedback action type, and determining, based on the calculation manner of the posture change parameter, a posture change parameter of a feedback action of the first feedback action type relative to the matching part includes:
obtaining, when the first feedback action type is a single feedback action, a feedback action sequence corresponding to the matching part, the feedback action sequence including at least two pre-configured actions; and
determining a to-be-fed back action from the at least two pre-configured actions, and using an animation parameter of the to-be-fed back action as the posture change parameter of the feedback action of the first feedback action type relative to the matching part.

The single feedback action is a feedback action that is performed only once, that is, a one-time feedback action. For example, the single feedback action may be specifically a posture change that is performed only once. The feedback action sequence is a sequence including at least two pre-configured actions, and the at least two pre-configured actions in the feedback action sequence and a sequence of actions may be configured according to an actual application scenario.

Specifically, when the first feedback action type is the single feedback action, the terminal obtains the feedback action sequence corresponding to the matching part. The feedback action sequence includes at least two pre-configured actions. The terminal may determine the to-be-fed back action from the at least two pre-configured actions, and use the animation parameter of the to-be-fed back action as the posture change parameter of the feedback action of the first feedback action type relative to the matching part.

In a specific application, the feedback action sequence may include a single animation feedback action and a one-layer state switching action that are in mixed arrangement. Actions in the feedback action sequence may be implemented in sequence, until the feedback action sequence is cleared, to return to a default posture of the virtual object. In a specific application, the single animation feedback action is an animation feedback action that is performed only once, for example, ears of the virtual object shake once. One-layer state is a basic posture of the virtual object, and may be configured according to an actual application scenario. One-layer state switching is switching between one-layer states. For example, the one-layer state may specifically include five basic postures: standing, squatting, lying prone, leaning, and lying down.

In this embodiment, the feedback action sequence that includes the at least two pre-configured actions corresponding to the matching part is obtained, the to-be-fed back action is determined in the at least two pre-configured actions, and the animation parameter of the to-be-fed back action is used as the posture change parameter of the feedback action of the first feedback action type relative to the matching part, so that the posture change parameter can be determined by using the feedback action sequence.

In an embodiment, the virtual object interaction method further includes:
determining, when the color value at the interaction location represents that the interaction operation acts on a background region in the virtual scene, that an interaction manner corresponding to the color value at the interaction location is a virtual scene lens switching interaction, and performing a virtual scene lens switching operation mapped at the interaction location.

The background region is a region in the virtual scene other than a region in which the virtual object is located. A lens is a tool for viewing a virtual scene, and displays a picture of the virtual scene on a terminal by photographing some regions of the virtual scene. A game is used as an example, a game picture is obtained by photographing some regions of the virtual scene by using the lens, and the interaction object can view pictures of different regions of the virtual scene by controlling movement of the lens.

Specifically, after identifying the color value at the interaction location, the terminal determines, by using the color value at the interaction location, whether the interaction operation acts on the background region in the virtual scene. When the color value at the interaction location represents that the interaction operation acts on the background region in the virtual scene, the terminal determines that the interaction manner corresponding to the color value at the interaction location is the virtual scene lens switching interaction, and performs the virtual scene lens switching operation mapped at the interaction location according to a mapping relationship between the interaction location and the virtual scene lens switching direction. In a specific application, the mapping relationship between the interaction location and the virtual scene lens switching direction may be configured according to an actual application scenario, and a lens may be rotated in 360 degrees through configuration of the mapping relationship.

In a specific application, the terminal may determine, by comparing the color value at the interaction location with the color value threshold, whether the interaction operation acts on the background region in the virtual scene. When the color value at the interaction location is equal to the color value threshold, it represents that the interaction operation acts on the background region. The color value threshold may be configured according to an actual application scenario. For example, the color value threshold may be specifically 0, which represents that when the color value at the interaction location is equal to 0, it is determined that the interaction operation acts on the background region.

In this embodiment, when the color value at the interaction location represents that the interaction operation acts on the background region in the virtual scene, it is determined that the interaction manner corresponding to the color value at the interaction location is the virtual scene lens switching interaction, and the virtual scene lens switching operation mapped at the interaction location is performed, so that an interaction feedback on virtual scene lens switching can be achieved.

In an embodiment, the virtual object interaction method in this application is described by being applied to virtual pet interaction.

The inventor considers that conventional virtual object interaction has some limitations, for example, an entire posture of a virtual object is fixed, and a lens of a virtual camera is fixed and cannot be rotated. The interaction manner is single, resources of the virtual object cannot be fully utilized, and a problem of low resource utilization exists.

Based on this, this application provides a virtual object interaction method, that is, a solution for virtual object simulated interaction, which may be applied to pet interaction in the game. An overall concept of the solution is to implement diversified virtual interaction such as click feedback, part dragging, state switching, and part following on a virtual object based on a virtual object partition identification technology and by using technologies such as sliding interaction, inverse kinematics, and a state machine.

In an embodiment, the virtual object interaction method in this application is described by using an example in which the method is applied to Unity-based virtual pet interaction.

FIG. 10 is a schematic diagram of interaction expected to be implemented by virtual pet interaction applied to a virtual object interaction method according to this application. A virtual object triggers different parts at different postures to generate different feedbacks. The feedback includes: posture switching, a loop action (that is, a continuous feedback action), one-time feedback, emotion feedback, paw inverse kinematics, and the like. The emotion feedback includes that strong feedback or posture switching is generated when weak feedback is accumulated. In other words, an accumulated feedback event is triggered when accumulated interaction time satisfies a first accumulated feedback trigger condition or an accumulated quantity of times of interaction satisfies a second accumulated feedback trigger condition. For example, an example in which a virtual pet is a virtual cat is used. When a body of the virtual cat is petted for a certain amount of time, the cat may roll on the ground. In addition, some randomness of feedback may be increased. For example, the feedback action sequence is introduced to provide abundant simulated interaction experience for the interaction object. For another example, as shown in FIG. 10, through strong feedback and random posture switching, the randomness of feedback is greatly improved, and “petting the virtual cat to get it to lay on its back” may be implemented. In addition, different feedbacks are given in response to touching at an entire part and touching at a sensitive part.

Specifically, the virtual object interaction method in this application mainly relates to the following technologies: the first is a partition-to-interaction technology, the second is a face-following sliding interaction technology, and the third is a foot inverse kinematics sliding interaction technology and an animation state machine. The following separately describes the technologies.

### 1. Partition-to-Interaction Technology

In this application, a virtual object is partitioned by using a part partition texture map, different parts are endowed with different color values, and a rendered screen render texture map is obtained after skinning. Then, in response to an interaction operation triggered in a virtual scene, a color value at an interaction location indicated by the interaction operation may be identified to determine a matching part, and then interaction is performed based on the matching part. Consumption of color value identification through part partitioning in this application is very small. Therefore, for a continuous operation, trigger operation identification may be performed on each frame of the virtual scene in a process of the continuous operation, to identify the color value, so that the interaction location may be switched during sliding, for example, touching a head is switched to touching a body.

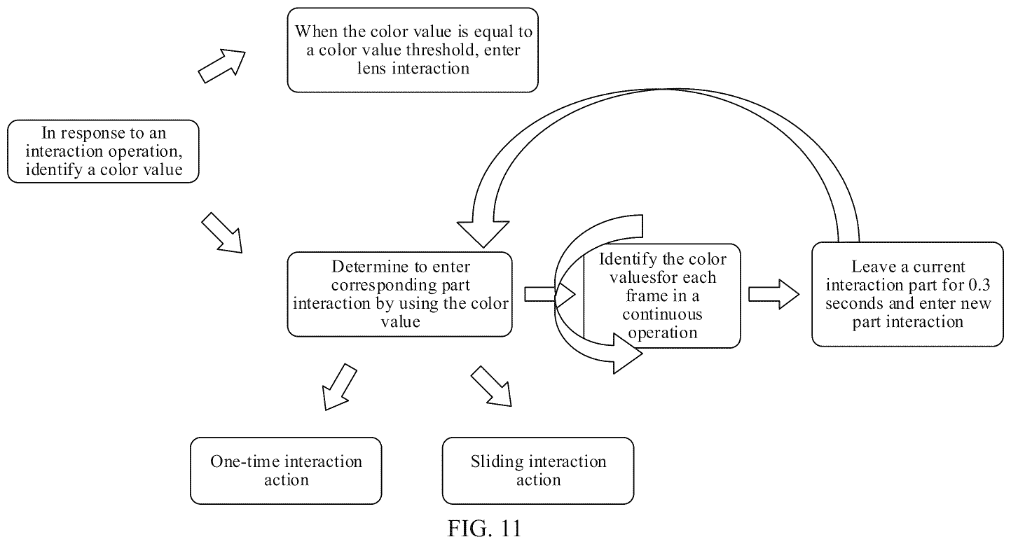

Specifically, an interaction flowchart may be shown in FIG. 11. When the virtual object exists in the virtual scene, the terminal identifies, in response to the interaction operation triggered in the virtual scene, the color value at the interaction location indicated by the interaction operation. When the color value at the interaction location is equal to the color value threshold, it represents that the interaction operation acts on the background region, and lens interaction is entered. When the color value at the interaction location is greater than the color value threshold, it represents that the interaction operation acts on the virtual object, the terminal determines to enter corresponding part interaction by using the color value. The part interaction includes a one-time interaction action, a sliding interaction action, an inverse kinematics interaction action, basic posture switching, and the like (FIG. 11 only shows the one-time interaction action and the sliding interaction action, where the one-time interaction action and the basic posture switching may be understood as single feedback actions, and the sliding interaction action and the inverse kinematics interaction action may be understood as continuous feedback actions).

In a specific application, the terminal determines, from the pre-configured correspondence between the part of the virtual object and the color value according to the color value at the interaction location, the part of the virtual object matching the color value at the interaction location, obtains the posture data of the virtual object, determines, based on the pre-configured mapping relationship among the posture of the virtual object, the part of the virtual object, and the feedback action type, the first feedback action type matching the posture data and the matching part, determines the calculation manner of the posture change parameter corresponding to the first feedback action type, determines, based on the calculation manner of the posture change parameter, the posture change parameter of the feedback action of the first feedback action type relative to the matching part, and controls, based on the posture change parameter, the virtual object to perform the feedback action corresponding to the matching part.

In a specific application, when the part interaction is entered, if the first feedback action type is the continuous feedback action, the terminal performs trigger operation identification on each frame of the virtual scene in a process of the continuous operation, to identify a color value of a trigger location indicated by each trigger operation in the continuous operation, and determines the posture change parameter corresponding to the color value at the trigger location and the matching part.

In a specific application, when the part corresponding to the color value at the trigger location is the same as the matching part, the terminal may directly perform posture change parameter calculation based on the trigger location and the matching part, to obtain the posture change parameter. When the part corresponding to the color value at the trigger location is different from the matching part and the part corresponding to the color value at the trigger location satisfies the interaction part update condition (FIG. 11 shows that the part corresponding to the color value at the trigger location continuously leaves a current interaction part for 0.3 seconds), the part corresponding to the color value at the trigger location is determined as the interaction part, that is, new part interaction is entered, the interaction posture of the virtual object corresponding to a moment at which the trigger operation is triggered is obtained, and posture change parameter calculation is performed based on the interaction part and the interaction posture, to obtain the posture change parameter. When the part corresponding to the color value at the trigger location is different from the matching part and the part corresponding to the trigger location does not satisfy the interaction part update condition, the posture control parameter corresponding to the matching part is used as the posture change parameter.

### 2. Face-Following Sliding Interaction Technology

Specifically, to simulate real feedback of the virtual object touching its head and scratching its chin in the real world as much as possible, degrees of horizontal and up-and-down rotation of the face of the virtual object may be separately controlled by using two parameters, the horizontal direction control parameter and the vertical direction control parameter. The two parameters are combined to implement 360-degree rotation of the face of the virtual object within a certain range. In a process of implementing the face-following sliding interaction, in this solution, a nose of the virtual object is used as the center of the face, and the nose is used as a boundary to control the virtual object to shake left and right and shake up and down. When the virtual object is controlled to shake up and down, it is required that when a head of the virtual object is petted, the virtual object lower the head and shakes within a range, and when a chin of the virtual object is petted, the virtual object raises the head and shakes. Therefore, the facial animation parameter range of the virtual object is approximately a case shown in FIG. 7 (a virtual object in FIG. 7 is a virtual cat). A sudden change occurs in the vertical direction control parameter at the nose. In this application, when switching is performed in the upper half region and the lower half region, short animation mixing is performed to achieve up-and-down rotation of the face smoother and more natural.

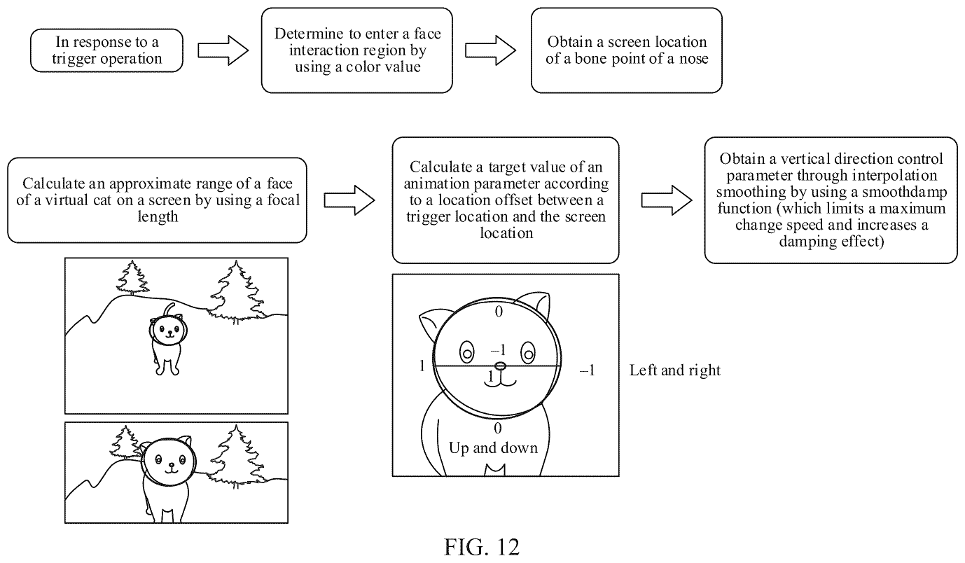

In a specific application, as shown in FIG. 12, face sliding interaction is described by using an example in which a virtual object is a virtual cat. In response to a trigger operation, after determining to enter a face interaction region by using a color value, a terminal first obtains a screen location of a bone point of a nose, then calculates, by using a focal length, an approximate range of a face of the virtual cat on the screen, that is, a screen range of the face, determines a location offset between the screen location and the trigger location, and calculates, according to the location offset and a facial animation parameter range corresponding to the screen range, a target value of an animation parameter, that is, an animation parameter corresponding to the trigger location within the facial animation parameter range. For a vertical direction control parameter in the animation parameter corresponding to the trigger location, the terminal obtains the vertical direction control parameter through interpolation smoothing by using a smoothdamp function, that is, obtains a vertical direction initial parameter of the face, performs smoothing interpolation between the vertical direction initial parameter and the vertical direction control parameter, to obtain the interpolated vertical direction control parameter, and uses the horizontal direction control parameter and the interpolated vertical direction control parameter as the posture change parameters. The smoothdamp function is a spring damping effect, and may further limit a maximum change speed.

### 3. Foot Inverse Kinematics Sliding Interaction Technology

Specifically, an expected objective of foot sliding interaction is that the trigger operation on the interaction object may pull the foot of the virtual object to move. Therefore, an inverse kinematics technology is introduced in this application. The inverse kinematics technology is introduced, only a location of the foot of the virtual object needs to be determined when the interaction object slides on a screen, and motion of another part, such as a hand, of the virtual object is inversely driven through inverse kinematics.

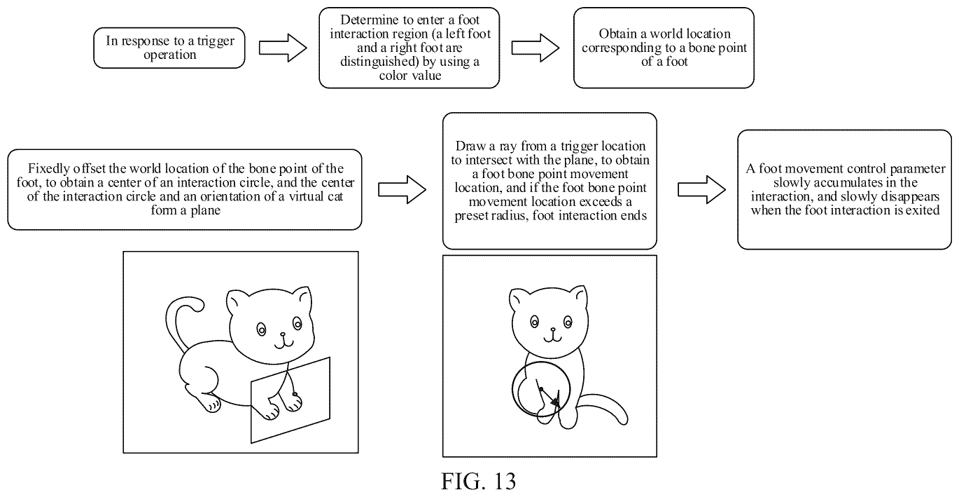

In a specific application, as shown in FIG. 13, foot sliding interaction is described by using an example in which the virtual object is the virtual cat. In response to the trigger operation, after determining to enter a foot interaction region (a left foot and a right foot are distinguished) by using the color value, the terminal obtains a world location of a bone point of a foot, and offsets the world location of the bone point of the foot of the virtual cat upward by a preset distance which is fixed, to obtain a center of an interaction circle. The center of the interaction circle and an orientation (an orientation axis) of the virtual cat form a plane in which the virtual cat is located. An interaction radius is determined according to a size of the virtual cat, and an interaction range of the foot is determined based on the center of the interaction circle and the interaction radius. In response to each trigger operation in the continuous sliding operation of the interaction object, the terminal draws a ray from the trigger location indicated by the trigger operation to intersect with a plane in which the virtual object is located, to obtain a foot bone point movement location, that is, determines a plane intersection point of the trigger location indicated by the trigger operation relative to the plane in which the virtual object is located. The foot interaction is ended if the foot bone point movement location exceeds the interaction radius.

In a specific application, if the foot bone point movement location is within the interaction range of the foot, the terminal performs bone point movement deduction based on the foot bone point movement location, to obtain the parent bone point movement location of each level of parent bone points on the bone chain in which the bone point of the foot is located, and obtains the posture change parameter based on the foot bone point movement location and the parent bone point movement location.

In a specific application, in a process of the foot interaction, a foot movement control parameter slowly accumulates to move the foot toward the foot bone point movement location. When the foot interaction is exited, the foot movement control parameter slowly decreases, so that the movement of the foot looks more natural when the foot interaction is entered and exited.

### 4. Animation State Machine

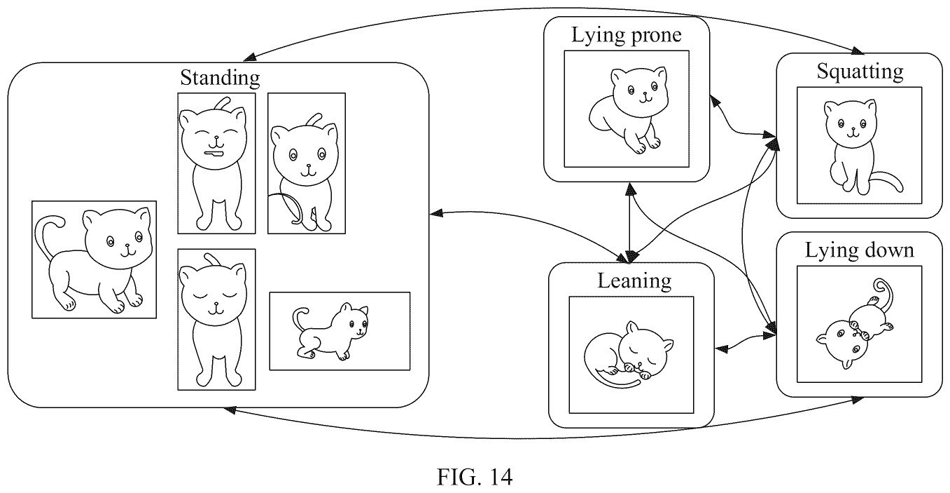

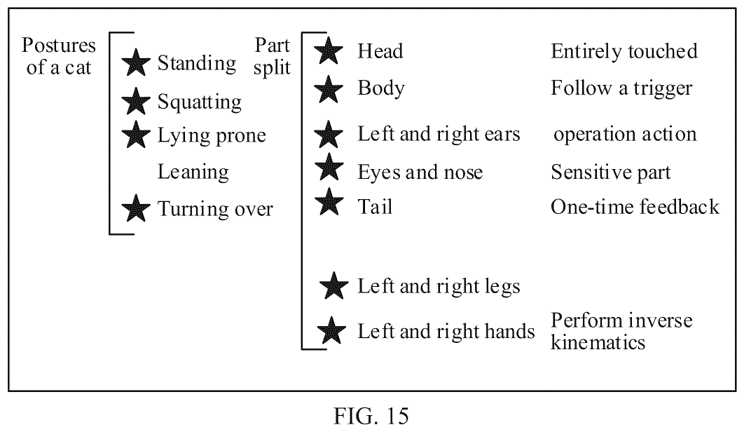

Specifically, to implement diversity of virtual object interaction, in this application, a double-layer state machine is used to implement an entire interaction framework. The virtual object itself has five different basic postures. As shown in FIG. 14, that the virtual object is the virtual cat is used as an example, including five basic postures: standing, squatting, lying prone, leaning, and lying down. As shown in FIG. 15, in the animation state machine, the five basic postures form a first-layer state machine. Each first-layer posture further has a second-layer state machine inside. The second-layer state machine has a default posture, for example, a standing posture loop (that is, when the posture of the virtual cat is standing, a corresponding fixed animation is played), and several interaction postures, which are referred to as second-layer postures herein, such as face sliding interaction, inverse kinematics sliding interaction, and single animation feedback (for example, ears shake once) that are achieved above. In this embodiment, as shown in FIG. 15, the virtual cat is split into a plurality of different parts, and each part has a corresponding interaction posture. For the head and the body, the part may be entirely touched, and may follow a trigger operation action. The one-time feedback may be performed for sensitive parts such as the left and right ears, the eyes, the nose, and the tail, and the inverse kinematics feedback may be performed for left and right legs and left and right hands.

When the interaction object performs interaction with any part, the virtual cat switches from any current second-layer posture to a next correspondingly configured second-layer interaction posture or switches to a state of the first-layer state machine. After the interaction ends, or when the virtual cat returns to a default second-layer posture or the accumulated feedback event is triggered, the virtual cat enters the feedback action mapped to the accumulated feedback event.

In a specific application, to implement the foregoing double-layer state machine framework, a program implementation layer defines an abstract behavior of the virtual cat, and the abstract behavior includes three types: The first is single animation feedback (for example, ears shake once), the second is a loop animation (face sliding interaction, inverse kinematics sliding interaction, or another fixed loop animation (for example, when the body is touched, a fixed loop animation is played), and the third is posture switching of the first-layer state machine. The virtual cat generates different feedbacks, that is, performs different feedback actions, in different parts of interaction with different postures. For example, when a cat is standing or squatting, long-pressing and sliding (that is, a continuous operation) on the face triggers the face sliding interaction, long-pressing and sliding on the foot triggers the inverse kinematics interaction, and clicking on the ear triggers an ear shaking animation.

In a specific application, for richness, this application introduces a behavior sequence including single animation feedback and one-layer state switching that are in mixed arrangement. The animations within the sequence are played in sequence until the sequence is cleared, to return to the default posture. In addition, this application further introduces an accumulated counting and randomness of interaction. For example, there is a probability of switching a basic posture by continuously clicking the ear three times. The introduced behavior sequence, accumulated counting, randomness of interaction, and the like may be configured according to an actual application scenario.

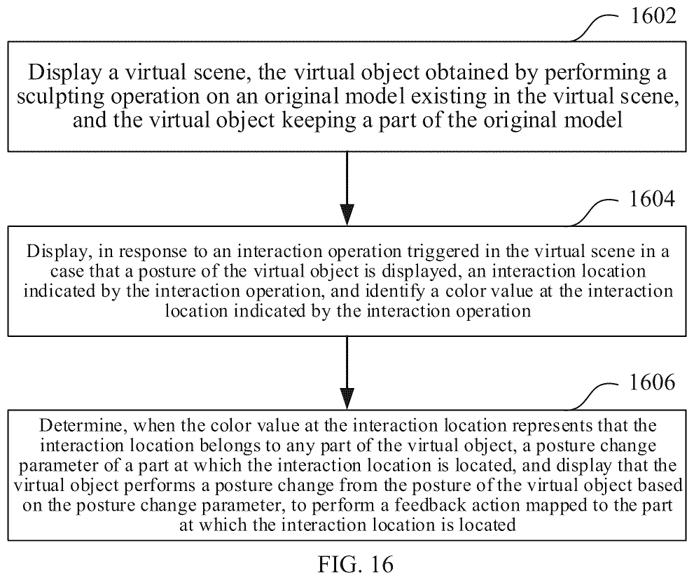

In an embodiment, as shown in FIG. 16, a virtual object interaction method is provided. The method may be independently performed by a terminal or a server, or may be jointly performed by a terminal and a server. In the embodiments of this application, an example in which the method is applied to the terminal is used for description. The method includes the following operations:

Operation 1602: Display a virtual scene, a virtual object obtained by performing a sculpting operation on an original model existing in the virtual scene, and the virtual object keeping a part of the original model.

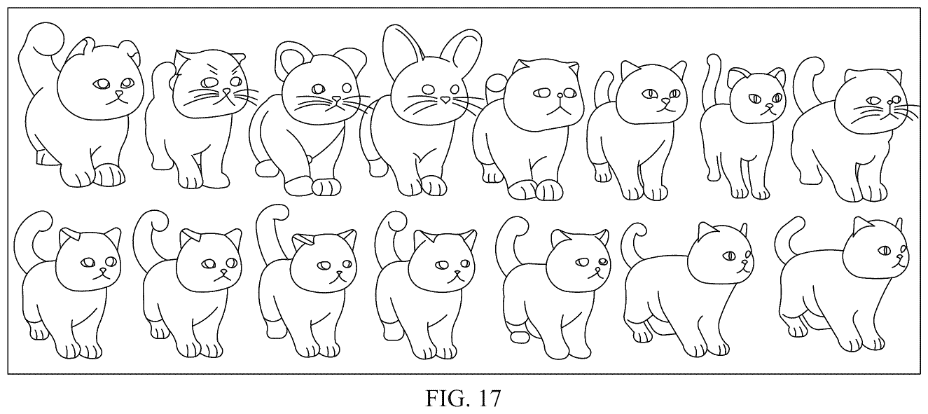

The original model is a model that has not been sculpted. The virtual object is a movable object obtained by performing a sculpting operation on an original model in a virtual environment, and the movable object may be a virtual person, a virtual animal, or the like. For example, the original model may be specifically an animal model that has not been sculpted, and the virtual object is a virtual animal obtained by performing a sculpting operation on the original model. For example, the original model may be specifically a model of a cat that has not been sculpted, and the virtual object is a cat obtained by performing a sculpting operation on the original model. To further illustrate, as shown in FIG. 17, virtual cats of different body shapes may be obtained by performing a sculpting operation on the model of the cat that has not been sculpted.

Specifically, the terminal displays the virtual scene. The virtual object obtained by performing a sculpting operation on an original model exists in the virtual scene, and the virtual object keeps a part of the original model. In a specific application, the original model includes a plurality of parts, and sizes of the plurality of parts may be changed through the sculpting operation. As shown in FIG. 17, different virtual cats have different body shapes. Actually, sizes of parts of the different cats are not exactly the same. However, the different virtual cats each include six parts: eyes, ears, a face, front paws, a body, and a tail. In a specific application, when displaying the virtual object obtained by performing the sculpting operation on the original model, the terminal may further display a background region corresponding to the virtual object. The background region may be configured according to an actual application scenario.

Operation 1604: Display, in response to an interaction operation triggered in the virtual scene when a posture of the virtual object is displayed, an interaction location indicated by the interaction operation, and identify a color value at the interaction location indicated by the interaction operation.

The interaction operation is an operation triggered when an interaction object performs interaction. For example, the interaction operation may be specifically a click operation triggered when the interaction object performs interaction. For example, the interaction operation may be specifically a click operation triggered by an input device when the interaction object performs interaction. The input device may be specifically a mouse, a stylus, or the like. For another example, the interaction operation may be specifically a touch screen operation triggered when the interaction object performs interaction. The interaction location is a location at which the interaction operation is triggered. For example, when an interaction trigger operation is the click operation, the interaction location may be specifically a clicked location. For another example, when the interaction operation is a touch screen operation, the interaction location may be specifically a touched screen location.

Specifically, when the posture of the virtual object is displayed, the terminal obtains the part partition texture map corresponding to the virtual object, renders the virtual object based on the part partition texture map, to obtain the color texture map, and waits to respond to the interaction operation for the virtual object. If the interaction object wants to perform interaction, the interaction operation is initiated, and the terminal displays, in response to the interaction operation, the interaction location indicated by the interaction operation, so that the interaction object can intuitively learn the interaction location selected by the interaction object and identify the color value at the interaction location indicated by the interaction operation.

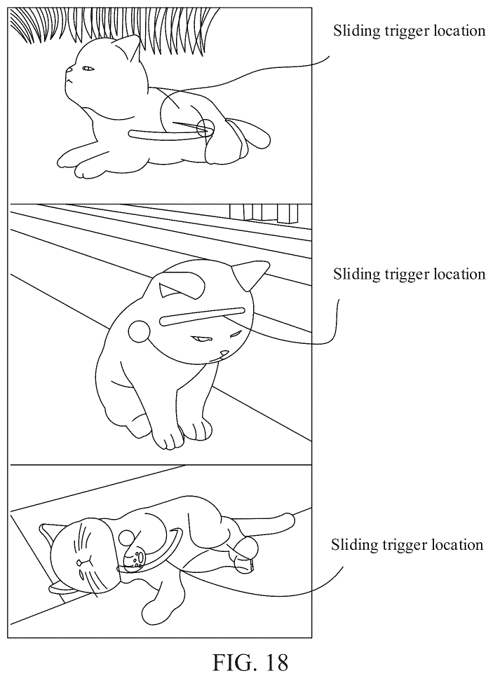

In a specific application, the interaction operation may be the start trigger operation of the continuous operation, and as the continuous operation is performed, the terminal displays a sliding trigger location of the continuous operation. In a specific application, the virtual object may be specifically the virtual cat. As shown in FIG. 18, when the continuous operation is sliding for a body of the virtual cat, the terminal displays a corresponding sliding trigger location in a region in which the body of the virtual cat is located. When the continuous operation is sliding for a region in which a head of the virtual cat is located, the terminal displays the sliding trigger location in the region in which the head of the virtual cat is located.

In a specific application, when the interaction location is determined, the terminal converts the interaction location indicated by the interaction operation into first texture coordinates, performs color value identification according to the first texture coordinates, to obtain a texture color value corresponding to the first texture coordinates, and obtains the color value at the interaction location indicated by the interaction operation based on the texture color value. In a specific application, when the interaction location indicated by the interaction operation is converted into the first texture coordinates, the terminal renders the color texture map onto the pre-configured screen render texture map, and may perform, according to the first texture coordinates, texture sampling on the screen render texture map on which the color texture map has been rendered, to obtain the texture color value corresponding to the first texture coordinates.

Operation 1606: Determine, when the color value at the interaction location represents that the interaction location belongs to any part of the virtual object, a posture change parameter of a part at which the interaction location is located, and display that the virtual object performs a posture change from the posture of the virtual object based on the posture change parameter, to perform a feedback action mapped to the part at which the interaction location is located.

The part at which the interaction location is located is a part selected by the interaction object for interaction. For example, the part at which the interaction location is located may be specifically eyes, a face, ears, a body, or the like. The feedback action mapped to the part at which the interaction location is located is an interaction action generated by the virtual object in response to interaction on the part at which the interaction location is located. For example, the feedback action mapped to the part at which the interaction location is located may be specifically posture switching. For example, the posture switching may be specifically that the virtual object changes from standing to postures such as lying prone, sitting, leaning, or lying down. For another example, the feedback action mapped to the part at which the interaction location is located may be specifically the continuous feedback action. For example, when the part at which the interaction location is located is the face, the feedback action mapped to the face may be specifically lowering a head, raising a head, or the like.

Specifically, when the color value at the interaction location represents that the interaction location belongs to any part of the virtual object, the terminal determines the posture change parameter of the part at which the interaction location is located, and displays that the virtual object performs a posture change from the posture of the virtual object based on the posture change parameter, to perform the feedback action mapped to the part at which the interaction location is located. In a specific application, when the color value at the interaction location represents that the interaction operation acts on the virtual object, the terminal may determine, from the pre-configured correspondence between the part of the virtual object and the color value according to the color value at the interaction location, the part matching the color value at the interaction location, that is, the part at which the interaction location is located, obtain the posture data of the virtual object, determine the first feedback action type matching the posture data and the part at which the interaction location is located, determine the posture change parameter of the feedback action of the first feedback action type relative to the part at which the interaction location is located, and control the virtual object to perform the feedback action mapped to the part at which the interaction location is located based on the posture change parameter.

According to the foregoing virtual object interaction method, the virtual object obtained by performing the sculpting operation on the original model existing in the virtual scene is displayed. When the posture of the virtual object is displayed, in response to the interaction operation triggered in the virtual scene, the interaction location indicated by the interaction operation is displayed, and the color value at the interaction location indicated by the interaction operation is identified, so that direct feedback on the interaction trigger operation can be achieved. In this way, when the color value at the interaction location represents that the interaction location belongs to any part of the virtual object, the posture change parameter of the part at which the interaction location is located is determined, and that the virtual object performs a posture change from the posture of the virtual object is displayed based on the posture change parameter, to perform the feedback action mapped to the part at which the interaction location is located, so that diversified feedback on the virtual object can be achieved with reference to the part at which the interaction location is located, the posture of the virtual object, and the feedback action, and resources of the virtual object can be fully utilized, thereby improving resource utilization.

In an embodiment, the displaying, when the interaction location belongs to any part of the virtual object, that the virtual object performs a posture change from the posture of the virtual object, to perform a feedback action mapped to the part in which the interaction location is located includes:
displaying, when the interaction location belongs to any part of the virtual object, and the first feedback action type matching the posture of the virtual object and the part at which the interaction location is located is the continuous feedback action, that the virtual object performs a posture change from the posture of the virtual object, to perform the continuous feedback action mapped to the part at which the interaction location is located.

Specifically, when the interaction location belongs to any part of the virtual object, and the first feedback action type matching the posture of the virtual object and the part at which the interaction location is located is the continuous feedback action, the terminal uses the interaction operation as the start trigger operation of the continuous operation corresponding to the continuous feedback action, and starting from the start trigger operation, determines, in response to the continuous operation, the posture change parameter corresponding to the continuous operation and the part at which the interaction location is located, to control the virtual object to perform a posture change from the posture of the virtual object based on the posture change parameter, to perform the continuous feedback action mapped to the part at which the interaction location is located.

In a specific application, for the continuous feedback action, the determined posture change parameter is a posture change parameter corresponding to each trigger operation in the continuous operation corresponding to the continuous feedback action. Therefore, when controlling, based on the posture change parameter, the feedback action mapped to the part at which the interaction location of the virtual object is located, for each trigger operation, the terminal controls, based on the trigger operation, the virtual object to perform the feedback action corresponding to the trigger operation and the part at which the interaction location is located.

In this embodiment, when the first feedback action type is the continuous feedback action, a continuous feedback action that is performed by the virtual object and that is mapped to the part at which the interaction location is located can be displayed, so that diversified feedback on the virtual object can be achieved, and resources of the virtual object can be fully utilized, thereby improving resource utilization.

In an embodiment, the displaying, when the interaction location belongs to any part of the virtual object, that the virtual object performs a posture change from the posture of the virtual object, to perform a feedback action mapped to the part in which the interaction location is located includes:
displaying, when the interaction location belongs to any part of the virtual object, and the first feedback action type matching the posture of the virtual object and the part at which the interaction location is located is the single feedback action, that the virtual object performs a posture change from the posture of the virtual object, to perform the single feedback action mapped to the part at which the interaction location is located.

Specifically, when the interaction location belongs to any part of the virtual object, and the first feedback action type matching the posture of the virtual object and the part at which the interaction location is located is the single feedback action, the terminal obtains the feedback action sequence corresponding to the matching part, and determines the posture change parameter based on the feedback action sequence, to control the virtual object to perform a posture change from the posture of the virtual object based on the posture change parameter, to perform the single feedback action mapped to the part at which the interaction location is located.

In a specific application, for the single feedback action, the determined posture change parameter is a posture change parameter of the single feedback action, and the terminal directly controls, based on the posture change parameter of the single feedback action, the virtual object to perform the feedback action mapped to the part at which the interaction location is located. In a specific application, it is assumed that the virtual object is the virtual pet, the matching part is the ear, the first feedback action type matching the posture data and the part at which the interaction location is located is the single feedback action, and the feedback action is that ears shake once, the terminal may obtain an animation parameter configured for implementing the ears to shake once, and control, according to the animation parameter, the virtual pet to perform the feedback action of shaking ears once corresponding to the ear.

In this embodiment, when the first feedback action type is the single feedback action, the single feedback action that is performed by the virtual object and that is mapped to the part at which the interaction location is located is displayed, so that diversified feedback on the virtual object can be achieved, and resources of the virtual object can be fully utilized, thereby improving resource utilization.

Operations in flowcharts involved in the foregoing embodiments are displayed in sequence based on indication of arrows, but the operations are not necessarily performed in sequence based on a sequence indicated by the arrows. Unless otherwise explicitly specified in this specification, the operations are performed without any strict sequence limit, and may be performed in other sequences. In addition, at least some operations in the flowcharts involved in the foregoing embodiments may include a plurality of operations or a plurality of stages, and these operations or stages are not necessarily performed at a same moment, but may be performed at different moments. The operations or stages are not necessarily performed in sequence, but may be performed by turn or alternately with other operations or at least part of operations or stages in other operations.

Based on the same invention concept, an embodiment of this application further provides a virtual object interaction apparatus for implementing the virtual object interaction method involved in the foregoing. The implementation solution for solving the problem provided by this apparatus is similar to the implementation solution recorded in the foregoing method. Therefore, for the specific limitations in one or more embodiments of the virtual object interaction apparatus provided below, reference may be made to the foregoing limitations for the virtual object interaction method, and the description is not repeated herein again.

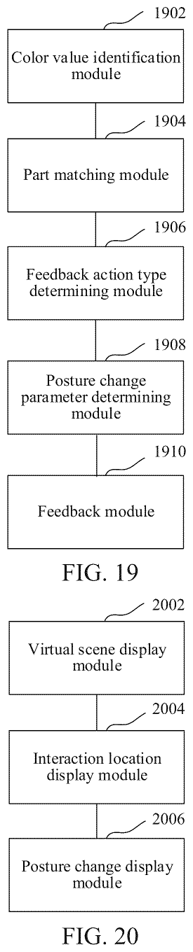

In an embodiment, as shown in FIG. 19, a virtual object interaction apparatus is provided, including: a color value identification module 1902, a part matching module 1904, a first feedback action type determining module 1906, a posture change parameter determining module 1908, and a feedback module 1910,
the color value identification module 1902 being configured to: identify, in response to an interaction operation triggered in a virtual scene when a virtual object exists in the virtual scene, a color value at an interaction location indicated by the interaction operation;
the part matching module 1904 being configured to: determine, from a pre-configured correspondence between a part of the virtual object and the color value according to the color value at the interaction location, a part of the virtual object matching the color value at the interaction location when the color value at the interaction location represents that the interaction operation acts on the virtual object, and obtain posture data of the virtual object, the posture data being configured for describing a posture of the virtual object;
the feedback action type determining module 1906 being configured to: determine, based on a pre-configured mapping relationship among the posture of the virtual object, the part of the virtual object, and a feedback action type, a first feedback action type matching the posture data and the matching part;
the posture change parameter determining module 1908 being configured to determine a calculation manner of a posture change parameter corresponding to the first feedback action type, and determine, based on the calculation manner of the posture change parameter, a posture change parameter of a feedback action of the first feedback action type relative to the matching part, the posture change parameter being a parameter configured for controlling the virtual object to perform a posture change; and
the feedback module 1910 being configured to control, based on the posture change parameter, the virtual object to perform a feedback action corresponding to the matching part.

According to the foregoing virtual object interaction apparatus, when the virtual object exists in the virtual scene, in response to the interaction operation triggered in the virtual scene, the color value at the interaction location indicated by the interaction operation is identified, and when the color value at the interaction location represents that the interaction operation acts on the virtual object, the part of the virtual object matching the color value of the interaction location is determined from the pre-configured correspondence between the part of the virtual object and the color value according to the color value at the interaction location. The matching part that needs interaction can be determined in a color value partition identification manner. The posture data of the virtual object is obtained, so that the posture data and the matching part can be combined. The first feedback action type is determined based on the pre-configured mapping relationship among the posture of the virtual object, the part of the virtual object, and the feedback action type. Further, on the basis of determining the first feedback action type, the calculation manner of the posture change parameter corresponding to the first feedback action type may be determined. The posture change parameter of the feedback action relative to the matching part is determined based on the calculation manner of the posture change parameter, so that the virtual object may be controlled, based on the posture change parameter, to perform the feedback action corresponding to the matching part. In an entire process, on the basis of determining the matching part by using the color value, diversified feedback on the virtual object can be achieved with reference to the matching part, the posture data, the first feedback action type, and the like, and resources of the virtual object can be fully utilized, thereby improving resource utilization.

In an embodiment, the color value identification module is further configured to: convert, when the virtual object exists in the virtual scene, in response to the interaction operation triggered in the virtual scene, the interaction location indicated by the interaction operation into first texture coordinates, and render a color texture map onto a pre-configured screen render texture map, the color texture map being a texture map obtained by rendering the virtual object based on a part partition texture map, and the part partition texture map including color values of parts of the virtual object; perform, according to the first texture coordinates, texture sampling on the screen render texture map on which the color texture map has been rendered, to obtain a texture color value corresponding to the first texture coordinates; and determine the color value at the interaction location indicated by the interaction operation based on the texture color value.

In an embodiment, the feedback module is further configured to trigger an accumulated feedback event when accumulated interaction time corresponding to the matching part satisfies a first accumulated feedback trigger condition; and control, in response to the accumulated feedback event, the virtual object to perform a feedback action mapped to the accumulated feedback event corresponding to the matching part.

In an embodiment, the feedback module is further configured to trigger an accumulated feedback event when an accumulated quantity of times of interaction corresponding to the matching part satisfies a second accumulated feedback trigger condition, and control, in response to the accumulated feedback event, the virtual object to perform a feedback action mapped to the accumulated feedback event corresponding to the matching part.

In an embodiment, the posture change parameter determining module is further configured to: use, when the first feedback action type is a continuous feedback action, the interaction operation as a start trigger operation of a continuous operation corresponding to the continuous feedback action, and starting from the start trigger operation, determine, in response to each trigger operation in the continuous operation, a posture change parameter corresponding to the trigger operation and the matching part.

In an embodiment, the posture change parameter determining module is further configured to: convert a trigger location indicated by the trigger operation into second texture coordinates, perform, according to the second texture coordinates, texture sampling on the screen render texture map on which the color texture map has been rendered, determine a color value of the trigger location indicated by the trigger operation, and determine a posture change parameter corresponding to the color value at the trigger location and the matching part.

In an embodiment, the posture change parameter determining module is further configured to: perform, when a part corresponding to the color value at the trigger location is the same as the matching part, posture change parameter calculation based on the trigger location and the matching part, to obtain the posture change parameter.

In an embodiment, the matching part is a face; and the posture change parameter determining module is further configured to: obtain a screen range of the face of the virtual object and a screen location of a facial central bone point; determine a location offset between the screen location and the trigger location; determine, based on the location offset and a facial animation parameter range corresponding to the screen range, an animation parameter corresponding to the trigger location within the facial animation parameter range; and obtain the posture change parameter based on the animation parameter corresponding to the trigger location.

In an embodiment, the animation parameter corresponding to the trigger location includes a horizontal direction control parameter and a vertical direction control parameter; and the posture change parameter determining module is further configured to obtain the vertical direction initial parameter of the face, perform smoothing interpolation between the vertical direction initial parameter and the vertical direction control parameter, to obtain the interpolated vertical direction control parameter, and use the horizontal direction control parameter and the interpolated vertical direction control parameter as the posture change parameters.

In an embodiment, the matching part is a foot; and the posture change parameter determining module is further configured to obtain a plane in which the virtual object is located, the plane in which the virtual object is located being obtained based on a world location of a bone point of a foot and an orientation axis of the virtual object; determine a plane intersection point of the trigger location relative to the plane in which the virtual object is located; use the plane intersection point as a foot bone point movement location of the bone point of the foot; and perform bone point movement deduction based on the foot bone point movement location, to obtain the posture change parameter.

In an embodiment, the posture change parameter determining module is further configured to: perform, when the foot bone point movement location is within the interaction scope of the foot, bone point movement deduction based on the foot bone point movement location, to obtain a parent bone point movement location of each level of parent bone points on a bone chain in which the bone point of the foot is located; and obtain the posture change parameter based on the foot bone point movement location and the parent bone point movement location.

In an embodiment, the posture change parameter determining module is further configured to: determine, based on a location of the bone point of the foot before moving and the foot bone point movement location, a foot movement control parameter that controls movement of the bone point of the foot; and use the foot movement control parameter and the parent bone point movement location as the posture change parameters.

In an embodiment, the posture change parameter determining module is further configured to: determine, when the part corresponding to the color value at the trigger location is different from the matching part and the part corresponding to the color value at the trigger location satisfies the interaction part update condition, the part corresponding to the color value at the trigger location as the interaction part; obtain the interaction posture of the virtual object corresponding to a moment at which the trigger operation is triggered; and perform posture change parameter calculation based on the interaction part and the interaction posture, to obtain the posture change parameter.

In an embodiment, the posture change parameter determining module is further configured to: use, when the part corresponding to the color value at the trigger location is different from the matching part and the part corresponding to the trigger location does not satisfy the interaction part update condition, the posture control parameter corresponding to the matching part as the posture change parameter.

In an embodiment, the posture change parameter determining module is further configured to: obtain, when the first feedback action type is a single feedback action, a feedback action sequence corresponding to the matching part, the feedback action sequence including at least two pre-configured actions; determine a to-be-fed back action from the at least two pre-configured actions; and use an animation parameter of the to-be-fed back action as the posture change parameter of the feedback action of the first feedback action type relative to the matching part.

In an embodiment, the virtual object interaction apparatus further includes a lens switching module. The lens switching module is configured to: determine, when the color value at the interaction location represents that the interaction operation acts on a background region in the virtual scene, that an interaction manner corresponding to the color value at the interaction location is a virtual scene lens switching interaction; and perform a virtual scene lens switching operation mapped at the interaction location.

In an embodiment, as shown in FIG. 20, a virtual object interaction apparatus is provided, including: a virtual scene display module 2002, an interaction location display module 2004, and a posture change display module 2006,
the virtual scene display module 2002 being configured to display a virtual scene, a virtual object obtained by performing a sculpting operation on an original model existing in the virtual scene; and the virtual object keeping a part of the original model;
the interaction location display module 2004 being configured to: display, in response to an interaction operation triggered in the virtual scene when a posture of the virtual object is displayed, an interaction location indicated by the interaction operation, and identify a color value at the interaction location indicated by the interaction operation; and
the posture change display module 2006 being configured to: determine, when the color value at the interaction location represents that the interaction location belongs to any part of the virtual object, a posture change parameter of a part at which the interaction location is located, and display that the virtual object performs a posture change from the posture of the virtual object based on the posture change parameter, to perform a feedback action mapped to the part at which the interaction location is located.

According to the foregoing virtual object interaction apparatus, the virtual object obtained by performing the sculpting operation on the original model existing in the virtual scene is displayed. When the posture of the virtual object is displayed, in response to the interaction operation triggered in the virtual scene, the interaction location indicated by the interaction operation is displayed, and the color value at the interaction location indicated by the interaction operation is identified, so that direct feedback on the interaction trigger operation can be achieved. In this way, when the color value at the interaction location represents that the interaction location belongs to any part of the virtual object, the posture change parameter of the part at which the interaction location is located is determined, and that the virtual object performs a posture change from the posture of the virtual object is displayed based on the posture change parameter, to perform the feedback action mapped to the part at which the interaction location is located, so that diversified feedback on the virtual object can be achieved with reference to the part at which the interaction location is located, the posture of the virtual object, and the feedback action, and resources of the virtual object can be fully utilized, thereby improving resource utilization.

In an embodiment, the posture change display module is further configured to: display, when the interaction location belongs to any part of the virtual object, and the first feedback action type matching the posture of the virtual object and the part at which the interaction location is located is the continuous feedback action, that the virtual object performs a posture change from the posture of the virtual object, to perform the continuous feedback action mapped to the part at which the interaction location is located.

In an embodiment, the posture change display module is further configured to: display, when the interaction location belongs to any part of the virtual object, and the first feedback action type matching the posture of the virtual object and the part at which the interaction location is located is the single feedback action, that the virtual object performs a posture change from the posture of the virtual object, to perform the single feedback action mapped to the part at which the interaction location is located.

The modules in the foregoing virtual object interaction apparatus may be implemented entirely or partially by software, hardware, or a combination thereof. The foregoing modules may be built in or independent of a processor of a computer device in a hardware form, or may be stored in a memory of a computer device in a software form, so that the processor invokes and performs an operation corresponding to each of the foregoing modules.

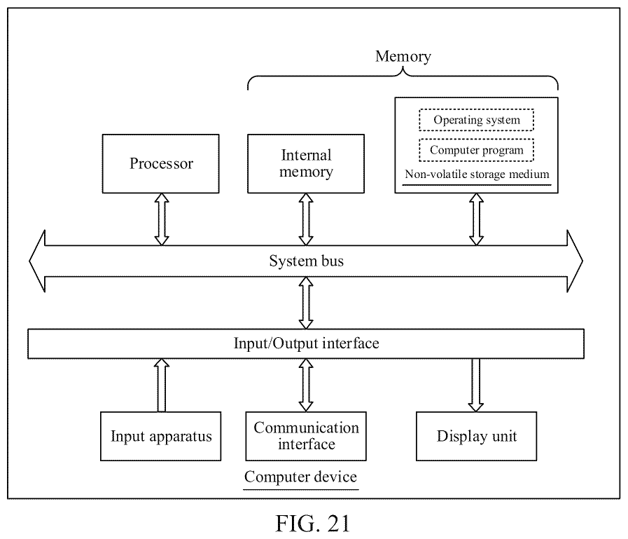

In an embodiment, a computer device is provided. The computer device may be a terminal or a server. For example, the computer device is the terminal, and an internal structure diagram thereof may be shown in FIG. 21. The computer device includes a processor, a memory, an input/output interface, a communication interface, a display unit, and an input apparatus. The processor, the memory, and the input/output interface are connected through a system bus, and the communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium stores an operating system and computer-readable instructions. The internal memory provides an environment for running of the operating system and the computer-readable instructions in the non-volatile storage medium. The input/output interface of the computer device is configured to exchange information between the processor and an external device. The communication interface of the computer device is configured to communicate with an external terminal in a wired or a wireless manner, and the wireless manner can be implemented by using WIFI, a mobile cellular network, a near field communication (NFC), or other technologies. The computer-readable instructions are executed by the processor to implement the virtual object interaction method. The display unit of the computer device is configured to form a visually visible picture, and may be a display screen, a projection apparatus, or a virtual reality imaging apparatus. The display screen may be a liquid crystal display screen or an electronic ink display screen. The input apparatus of the computer device may be a touch layer covering the display screen, or may be a key, a trackball, or a touch pad arranged on a housing of the computer device, or may be an external keyboard, a touch pad, a mouse, or the like.

A person skilled in the art may understand that, the structure shown in FIG. 21 is only a block diagram of a part of a structure related to a solution of this application and does not limit the computer device to which the solution of this application is applied. Specifically, the computer device may include more or fewer components than those in the drawings, or some components are combined, or a different component arrangement is used.

In an embodiment, a computer device is further provided, including a memory and a processor, the memory storing computer-readable instructions, the processor, when executing the computer-readable instructions, implementing the operations in the foregoing method embodiments.

In an embodiment, a non-transitory computer-readable storage medium is provided, storing computer-readable instructions, the computer-readable instructions, when executed by a processor, implementing the operations in the foregoing method embodiments.

In an embodiment, a computer program product is provided, storing computer-readable instructions, the computer-readable instructions, when executed by a processor, implementing the operations in the foregoing method embodiments.

A person of ordinary skill in the art may understand that all or some of the procedures of the methods of the foregoing embodiments may be implemented by using computer-readable instructions instructing relevant hardware. The computer-readable instructions may be stored in a non-volatile computer-readable storage medium. When the computer-readable instructions are executed, the procedures of the embodiments of the foregoing methods may be included. Any reference to a memory, a database, or another medium used in the embodiments provided in this application may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) or an external cache. For the purpose of description instead of limitation, the RAM may be in a plurality of forms, such as a static random access memory (SRAM) or a dynamic random access memory (DRAM). The database involved in the embodiments provided in this application may include at least one of a relational database and a non-relational database. The non-relational database may include a blockchain-based distributed database, but is not limited thereto. The processor involved in the embodiments provided in this application may be a general-purpose processor, a central processing unit, a graphics processing unit, a digital signal processor, a programmable logic device, a quantum computing-based data processing logic device, and are not limited thereto.

The technical features in the foregoing embodiments may be randomly combined. For concise description, not all possible combinations of the technical features in the embodiment are described. However, provided that combinations of the technical features do not conflict with each other, the combinations of the technical features are considered as falling within the scope recorded in this specification.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing embodiments only describe several implementations of this application, which are described specifically and in detail, but cannot be construed as a limitation to the patent scope of this application. A person of ordinary skill in the art may make various changes and improvements without departing from the ideas of this application, which shall all fall within the protection scope of this application. Therefore, the protection scope of this patent application is subject to the protection scope of the appended claims.

What is claimed is:

1. A virtual object interaction method performed by a computer device, the method comprising:
identifying, in response to an interaction operation on a virtual object in a virtual scene, a color value at an interaction location indicated by the interaction operation;
determining, from a pre-configured correspondence between respective parts of the virtual object and color values, a part of the virtual object matching the color value of the interaction location, and obtaining posture data of the virtual object;
determining a first feedback action type matching the posture data of the virtual object and the matching part of the virtual object; and
controlling, based on the first feedback action type, the virtual object to perform a feedback action corresponding to the matching part of the virtual object.

2. The method according to claim 1, wherein the identifying, in response to an interaction operation on a virtual object in a virtual scene, a color value at an interaction location indicated by the interaction operation comprises:
converting, in response to the interaction operation, the interaction location indicated by the interaction operation into first texture coordinates, and rendering a color texture map onto a pre-configured screen render texture map to obtain a screen render texture map; and
performing, according to the first texture coordinates, texture sampling on the screen render texture map, to obtain a texture color value corresponding to the first texture coordinates as the color value at the interaction location indicated by the interaction operation.

3. The method according to claim 1, wherein the method further comprises:
triggering an accumulated feedback event when accumulated interaction time corresponding to the matching part of the virtual object satisfies a first accumulated feedback trigger condition; and
controlling, in response to the accumulated feedback event, the virtual object to perform a feedback action mapped to the accumulated feedback event corresponding to the matching part of the virtual object.

4. The method according to claim 1, wherein the method further comprises:
triggering an accumulated feedback event when an accumulated quantity of times of interaction corresponding to the matching part of the virtual object satisfies a second accumulated feedback trigger condition; and
controlling, in response to the accumulated feedback event, the virtual object to perform a feedback action mapped to the accumulated feedback event corresponding to the matching part of the virtual object.

5. The method according to claim 1, wherein the controlling, based on the first feedback action type, the virtual object to perform a feedback action corresponding to the matching part of the virtual object comprises:
using, when the first feedback action type is a continuous feedback action, the interaction operation as a start trigger operation of a continuous operation corresponding to the continuous feedback action;
determining, in response to each trigger operation in the continuous operation and starting from the start trigger operation, a posture change parameter corresponding to the trigger operation and the matching part of the virtual object; and
controlling, based on the posture change parameter, the virtual object to perform the feedback action corresponding to the matching part of the virtual object.

6. The method according to claim 1, wherein the controlling, based on the first feedback action type, the virtual object to perform a feedback action corresponding to the matching part of the virtual object comprises:
obtaining, when the first feedback action type is a single feedback action, a feedback action sequence corresponding to the matching part of the virtual object, the feedback action sequence comprising at least two pre-configured actions; and
determining a to-be-fed back action from the at least two pre-configured actions, and using an animation parameter of the to-be-fed back action as a posture change parameter of the feedback action of the first feedback action type relative to the matching part; and
controlling, based on the posture change parameter, the virtual object to perform the feedback action corresponding to the matching part of the virtual object.

7. The method according to claim 1, wherein the method further comprises:
determining, when the color value at the interaction location represents that the interaction operation acts on a background region in the virtual scene, that an interaction manner corresponding to the color value at the interaction location is a virtual scene lens switching interaction; and
performing a virtual scene lens switching operation mapped at the interaction location.

8. A computer device, comprising a memory and a processor, the memory having computer-readable instructions stored therein, and the computer-readable instructions, when executed by the processor, causing the computer device to implement an virtual object interaction method including:
identifying, in response to an interaction operation on a virtual object in a virtual scene, a color value at an interaction location indicated by the interaction operation;
determining, from a pre-configured correspondence between respective parts of the virtual object and color values, a part of the virtual object matching the color value of the interaction location, and obtaining posture data of the virtual object;
determining a first feedback action type matching the posture data of the virtual object and the matching part of the virtual object; and
controlling, based on the first feedback action type, the virtual object to perform a feedback action corresponding to the matching part of the virtual object.

9. The computer device according to claim 8, wherein the identifying, in response to an interaction operation on a virtual object in a virtual scene, a color value at an interaction location indicated by the interaction operation comprises:
converting, in response to the interaction operation, the interaction location indicated by the interaction operation into first texture coordinates, and rendering a color texture map onto a pre-configured screen render texture map to obtain a screen render texture map; and
performing, according to the first texture coordinates, texture sampling on the screen render texture map, to obtain a texture color value corresponding to the first texture coordinates as the color value at the interaction location indicated by the interaction operation.

10. The computer device according to claim 8, wherein the method further comprises:
triggering an accumulated feedback event when accumulated interaction time corresponding to the matching part of the virtual object satisfies a first accumulated feedback trigger condition; and
controlling, in response to the accumulated feedback event, the virtual object to perform a feedback action mapped to the accumulated feedback event corresponding to the matching part of the virtual object.

11. The computer device according to claim 8, wherein the method further comprises:
triggering an accumulated feedback event when an accumulated quantity of times of interaction corresponding to the matching part of the virtual object satisfies a second accumulated feedback trigger condition; and
controlling, in response to the accumulated feedback event, the virtual object to perform a feedback action mapped to the accumulated feedback event corresponding to the matching part of the virtual object.

12. The computer device according to claim 8, wherein the controlling, based on the first feedback action type, the virtual object to perform a feedback action corresponding to the matching part of the virtual object comprises:
using, when the first feedback action type is a continuous feedback action, the interaction operation as a start trigger operation of a continuous operation corresponding to the continuous feedback action;
determining, in response to each trigger operation in the continuous operation and starting from the start trigger operation, a posture change parameter corresponding to the trigger operation and the matching part of the virtual object; and
controlling, based on the posture change parameter, the virtual object to perform the feedback action corresponding to the matching part of the virtual object.

13. The computer device according to claim 8, wherein the controlling, based on the first feedback action type, the virtual object to perform a feedback action corresponding to the matching part of the virtual object comprises:
obtaining, when the first feedback action type is a single feedback action, a feedback action sequence corresponding to the matching part of the virtual object, the feedback action sequence comprising at least two pre-configured actions; and
determining a to-be-fed back action from the at least two pre-configured actions, and using an animation parameter of the to-be-fed back action as a posture change parameter of the feedback action of the first feedback action type relative to the matching part; and
controlling, based on the posture change parameter, the virtual object to perform the feedback action corresponding to the matching part of the virtual object.

14. The computer device according to claim 8, wherein the method further comprises:
determining, when the color value at the interaction location represents that the interaction operation acts on a background region in the virtual scene, that an interaction manner corresponding to the color value at the interaction location is a virtual scene lens switching interaction; and
performing a virtual scene lens switching operation mapped at the interaction location.

15. A non-transitory computer-readable storage medium, having computer-readable instructions stored therein, the computer-readable instructions, when executed by a processor of a computer device, causing the computer device to implement a virtual object interaction method including:
identifying, in response to an interaction operation on a virtual object in a virtual scene, a color value at an interaction location indicated by the interaction operation;
determining, from a pre-configured correspondence between respective parts of the virtual object and color values, a part of the virtual object matching the color value of the interaction location, and obtaining posture data of the virtual object;
determining a first feedback action type matching the posture data of the virtual object and the matching part of the virtual object; and
controlling, based on the first feedback action type, the virtual object to perform a feedback action corresponding to the matching part of the virtual object.

16. The non-transitory computer-readable storage medium according to claim 15, wherein the identifying, in response to an interaction operation on a virtual object in a virtual scene, a color value at an interaction location indicated by the interaction operation comprises:
converting, in response to the interaction operation, the interaction location indicated by the interaction operation into first texture coordinates, and rendering a color texture map onto a pre-configured screen render texture map to obtain a screen render texture map; and
performing, according to the first texture coordinates, texture sampling on the screen render texture map, to obtain a texture color value corresponding to the first texture coordinates as the color value at the interaction location indicated by the interaction operation.

17. The non-transitory computer-readable storage medium according to claim 15, wherein the method further comprises:
triggering an accumulated feedback event when accumulated interaction time corresponding to the matching part of the virtual object satisfies a first accumulated feedback trigger condition; and
controlling, in response to the accumulated feedback event, the virtual object to perform a feedback action mapped to the accumulated feedback event corresponding to the matching part of the virtual object.

18. The non-transitory computer-readable storage medium according to claim 15, wherein the method further comprises:
triggering an accumulated feedback event when an accumulated quantity of times of interaction corresponding to the matching part of the virtual object satisfies a second accumulated feedback trigger condition; and
controlling, in response to the accumulated feedback event, the virtual object to perform a feedback action mapped to the accumulated feedback event corresponding to the matching part of the virtual object.

19. The non-transitory computer-readable storage medium according to claim 15, wherein the controlling, based on the first feedback action type, the virtual object to perform a feedback action corresponding to the matching part of the virtual object comprises:
using, when the first feedback action type is a continuous feedback action, the interaction operation as a start trigger operation of a continuous operation corresponding to the continuous feedback action;
determining, in response to each trigger operation in the continuous operation and starting from the start trigger operation, a posture change parameter corresponding to the trigger operation and the matching part of the virtual object; and
controlling, based on the posture change parameter, the virtual object to perform the feedback action corresponding to the matching part of the virtual object.

20. The non-transitory computer-readable storage medium according to claim 15, wherein the controlling, based on the first feedback action type, the virtual object to perform a feedback action corresponding to the matching part of the virtual object comprises:
obtaining, when the first feedback action type is a single feedback action, a feedback action sequence corresponding to the matching part of the virtual object, the feedback action sequence comprising at least two pre-configured actions; and
determining a to-be-fed back action from the at least two pre-configured actions, and using an animation parameter of the to-be-fed back action as a posture change parameter of the feedback action of the first feedback action type relative to the matching part; and
controlling, based on the posture change parameter, the virtual object to perform the feedback action corresponding to the matching part of the virtual object.
